(19) United States
(12) Patent Application Publication
(10) Pub. No.: US 2024/0409013 A1
(43) Pub. Date: Dec. 12, 2024

(54) CONVEYANCE SEAT

(71) Applicant: TS TECH CO., LTD., Asaka-shi, Saitama (JP)

(72) Inventors: Ryosuke KOJIMA, Tochigi (JP); Soichiro TANAKA, Tochigi (JP); Hajime YOSHIDA, Tochigi (JP)

(21) Appl. No.: 18/695,732

(22) PCT Filed: Sep. 27, 2022
(86) PCT No.: PCT/JP2022/036030

§ 371 Date: Mar. 26, 2024

Related U.S. Application Data
(60) Provisional application No. 63/249,138, filed on Sep. 28, 2021.
(60) Provisional application No. 63/273,276, filed on Oct. 29, 2021.

(30) Foreign Application Priority Data
Sep. 29, 2021 (JP) 2021-159661

(51) Int. Cl. B60N 2/56; H05B 1/02

(52) U.S. Cl. CPC B60N 2/5685; H05B 1/0238

(57) ABSTRACT

Provided is a conveyance seat capable of streamlining an operation of attaching a seat heater inside a seat body. A conveyance seat is disposed between a pad material and a skin material inside the seat body, and includes a seat heater attached to a back surface of the skin material. The pad material has pull-in grooves for pulling in a skin end portion of the skin material. The pull-in grooves are provided to partition the pad material into a first pad portion and a second pad portion. The seat heater has a first heater portion disposed on a surface of the first pad portion, a second heater portion disposed on a surface of the second pad portion, and heater connecting portions disposed to straddle the pull-in grooves to connect the first heater portion and the second heater portion. The heater connecting portions are attached to the skin end portion and pulled into the pull-in grooves together with the skin end portion.

### TECHNICAL FIELD

The present invention relates to a conveyance seat, and to a conveyance seat equipped with a sheet-shaped seat heater disposed between a pad material and a skin material inside a seat body.

### BACKGROUND ART

Conventionally, there has been a known conveyance seat that improves comfort of an occupant seated on a seat body by attaching a sheet-shaped seat heater inside the seat body.

As an example of the conveyance seat, there has been a known conveyance seat including a seat body configured by placing a pad material on a seat frame serving as a skeleton and covering the pad material with a skin material, and a seat heater disposed between the pad material and the skin material and attached to a back surface of the skin material using an adhesive, etc. (for example, see PATENT LITERATURE 1).

### CITATION LIST

### Patent Literature

PATENT LITERATURE 1: WO 2021/085093

### SUMMARY OF INVENTION

### Technical Problem

Incidentally, in the conveyance seat as in PATENT LITERATURE 1, the seat heater includes a front heater portion disposed on a front portion of the pad material in a seat cushion, a rear heater portion disposed on a rear portion of the pad material, and right and left heater connecting portions (heater passage portions) connecting the front heater portion and the rear heater portion.

Further, on a surface of the pad material, pull-in grooves for dividing the pad material into the front portion and the rear portion and pulling in a skin end portion of the skin material are formed, and the right and left heater connecting portions are pulled (pushed) in the pull-in grooves together with the skin end portion.

Then, in manufacturing the seat cushion, when covering the pad material with the skin material with the seat heater attached, it is necessary to push the heater connecting portions of the seat heater into the pull-in grooves, which leads to an increase in work costs.

Note that an operation of pushing the heater connecting portions into the pull-in grooves is a necessary operation even when, for example, the seat heater is attached to (stored in) the surface of the pad material.

Therefore, technology is needed to streamline an operation of attaching the seat heater (heater connecting portions) inside the seat body.

Furthermore, in the conveyance seat as in PATENT LITERATURE 1, the right and left heater connecting portions of the seat heater are disposed in the central portion of the pad material of the seat cushion in the seat width direction and disposed at positions overlapping with the pull-in grooves of the pad material.

Then, when the occupant sits on the seat body, load is applied to the heater connecting portions due to a seating load.

For this reason, technology is needed to inhibit load due to the seating load from being applied to the heater connecting portions in the seat heater.

The invention has been made in view of the above problems, and an object of the invention is to provide a conveyance seat capable of streamlining an operation of attaching a seat heater inside a seat body.

In addition, another object of the invention is to provide a conveyance seat in which heater connecting portions of a seat heater can be efficiently attached inside a seat body.

In addition, provided is a conveyance seat capable of inhibiting a load due to a seating load from being applied to heater connecting portions of a seat heater.

### Solution to Problem

According to a conveyance seat of the invention, the above problem is solved by a conveyance seat including a seat body including a pad material and a skin material covering the pad material, a sheet-shaped seat heater disposed between the pad material and the skin material inside the seat body and attached to a back surface on a side of the skin material, wherein the pad material has pull-in grooves each formed on a surface of the pad material and used to pull in a skin end portion of the skin material, the pull-in grooves extend along a predetermined direction on the surface of the pad material and are provided to partition the pad material into a first pad portion and a second pad portion, the seat heater has a first heater portion disposed on a surface of the first pad portion, a second heater portion disposed on a surface of the second pad portion, and heater connecting portions that are disposed to straddle the pull-in grooves, connect the first heater portion and the second heater portion, and are formed to be narrower than the first heater portion and the second heater portion, and the heater connecting portions are attached to the skin end portion of the skin material and are at least partially pulled into the pull-in grooves together with the skin end portion.

According to the above configuration, it is possible to realize a conveyance seat capable of streamlining an operation of attaching the seat heater inside the seat body.

Specifically, the heater connecting portions are attached to the skin end portion of the skin material, and pulled into the pull-in grooves together with the skin end portion. Therefore, an operation process of pushing the heater connecting portions into the pull-in grooves as in the past becomes unnecessary. That is, by pulling the skin end portion into the pull-in grooves, the heater connecting portions are also pulled in at the same time. Therefore, it becomes possible to efficiently attach the seat heater (heater connecting portion).

Further, according to the above configuration, when the skin material is attached to a predetermined position of the pad material, an attachment position of the seat heater is also determined. Therefore, an operation of attaching the skin material and the seat heater to the pad material is improved.

In this instance, the pull-in grooves may have first pull-in grooves for partitioning the pad material into a central pad portion and side pad portions located outside the central pad portion in a seat width direction, and second pull-in grooves for partitioning the central pad portion into a first central pad portion and a second central pad portion in the seat width direction and a direction orthogonal to a thickness direction of the pad material, and the heater connecting portions may be at least partially pulled into the first pull-in grooves together with the skin end portion, and be disposed at positions aligned with or overlapping the second pull-in grooves.

According to the above configuration, the right and left heater connecting portions are disposed closer to the outside of the central part in the seat width direction of the seat body, and thus it becomes possible to inhibit a load of a seating load from being applied to the heater connecting portion.

In this instance, the first heater portion and the second heater portion may be disposed at positions facing a portion of the seat body in contact with an occupant when the occupant is seated on the seat body, and be disposed at positions not facing the second pull-in grooves.

According to the above configuration, the first heater portion and the second heater portion can be disposed by avoiding a portion (second pull-in grooves) of the pad material to which a seating load is more likely to be applied when the occupant is seated. As a result, it becomes possible to suppress a load applied to the seat heater.

In this instance, the heater connecting portions may be disposed outside the first heater portion and the second heater portion in the seat width direction.

According to the above configuration, it is possible to inhibit a load of a seating load from being applied to the heater connecting portions disposed to straddle the pull-in grooves.

In this instance, the first pull-in grooves may be formed on right and left sides in the seat width direction, the heater connecting portions may be disposed on the right and left sides in the seat width direction, and the right and left heater connecting portions may be at least partially pulled into the right and left first pull-in grooves, respectively.

By including the right and left heater connecting portions as described above, it is possible to inhibit the seat heater from unintentionally moving (shifting) with respect to the pad material.

In this instance, the second pull-in grooves may have a plurality of second pull-in grooves dividing the central pad portion into the first central pad portion, the second central pad portion, and a third central pad portion in the orthogonal direction, the seat heater may have a first heater portion disposed on a surface of the first central pad portion, a second heater portion disposed on a surface of the second central pad portion, a third heater portion disposed on a surface of the third central pad portion, a first heater connecting portion connecting the first heater portion and the second heater portion, and a second heater connecting portion connecting the second heater portion and the third heater portion, and the first heater connecting portion and the second heater connecting portion may be disposed at positions aligned in the orthogonal direction.

In addition, the first pull-in grooves may be formed on the right and left sides in the seat width direction, the heater connecting portions may be disposed on the right and left sides in the seat width direction, and the right and left heater connecting portions may be disposed at overlapping positions in the orthogonal direction and the thickness direction of the pad material.

According to the above configuration, it is possible to further inhibit the seat heater from unintentionally moving with respect to the pad material.

In this instance, the seat heater may have a sheet-shaped seat base material and a heater wire that is attached to the seat base material and extends along the seat base material, and a portion of the heater wire attached to the seat base material of each of the heater connecting portions may extend along an extending direction of each of the heater connecting portions and extend while forming a plurality of bent portions.

In addition, the portion of the heater wire attached to the seat base material of each of the heater connecting portions may extend while forming a meandering shape or a zigzag shape.

As described above, by ensuring as much area as possible for the heater wire in the heater connecting portion, it is possible to distribute a load when viewed over the entire heater wire.

In this instance, an outer end portion of each of the heater connecting portions in the seat width direction may be attached to the skin end portion by sewing.

According to the above configuration, it is possible to further streamline an operation of attaching the seat heater. In particular, it is possible to more efficiently attach the heater connecting portions of the seat heater inside the seat body.

### Advantageous Effects of Invention

According to the invention, it is possible to realize a conveyance seat capable of streamlining an operation of attaching a seat heater inside a seat body. Specifically, a conventional operation process of pushing heater connecting portions into pull-in grooves as in the past is unnecessary. That is, by pulling skin end portions into skin pull-in grooves, heater connecting portions are pulled in at the same time.

In addition, according to the invention, an operation of attaching a skin material and a seat heater to a pad material is improved.

In addition, according to the invention, it is possible to inhibit a load of a seating load from being applied to heater connecting portions.

In addition, according to the invention, it is possible to suppress a load applied to a seat heater.

In addition, according to the invention, it is possible to inhibit a seat heater from unintentionally moving with respect to a pad material.

In addition, according to the invention, by ensuring as much area as possible for a heater wire in heater connecting portions, it is possible to distribute a load when viewed over the entire heater wire.

In addition, according to the invention, it is possible to further streamline an operation of attaching a seat heater. In particular, it is possible to more efficiently attach heater connecting portions of the seat heater.

### BRIEF DESCRIPTION OF DRAWINGS

FIG. 1 is an external perspective view of a conveyance seat according to the present embodiment.

FIG. 2 is a top view of a seat cushion.

FIG. 3 is a top view of a pad material of the seat cushion.

FIG. 4 is a bottom view of a skin material and a seat heater of the seat cushion, and is a diagram illustrating a state in which a heater connecting portion is attached to a skin end portion.

FIG. 5 is a cross-sectional view taken along line V-V of FIG. 2, and is a diagram illustrating a state in which the skin end portion and the heater connecting portion are partially pulled into pull-in grooves.

FIG. 6 is a top view of the seat heater.

FIG. 7A is an enlarged view of a main part of the seat heater, and is a diagram illustrating the heater connecting portion.

FIG. 7B is a diagram illustrating a modification example of the heater connecting portion.

FIG. 8 is a perspective view of a conveyance seat of a second embodiment.

FIG. 9 is a cross-sectional view taken along line IX-IX of FIG. 8, and is a diagram illustrating a state in which a skin end portion and a heater connecting portion are partially pulled into pull-in grooves.

FIG. 10 is a perspective view of a conveyance seat of a third embodiment.

FIG. 11 is a side sectional view of the conveyance seat.

FIG. 12 is an exploded perspective view of a pad material of the seat cushion.

FIG. 13 is a plan view of the pad material of the seat cushion.

FIG. 14 is a cross-sectional view taken along line XIV-XIV of FIG. 13.

FIG. 15A is a plan view of a pad material of a seat cushion of Modification Example 1.

FIG. 15B is a cross-sectional view taken along line XV-XV of FIG. 15A.

FIG. 16A is a plan view of a pad material of a seat cushion of Modification Example 2.

FIG. 16B is a cross-sectional view taken along line XVI-XVI of FIG. 15A.

FIG. 17 is a side view of a conveyance seat of a fourth embodiment.

FIG. 18 is a perspective view of a conveyance seat of a fifth embodiment.

FIG. 19 is a perspective view of a vibration generator.

FIG. 20A is a side view of a vibration generator of Modification Example 1.

FIG. 20B is a side view of a vibration generator of Modification Example 2.

FIG. 21 is a perspective view of a conveyance seat of a sixth embodiment.

FIG. 22 is a perspective view of a seat frame, a lumbar support, and a vibration generator.

FIG. 23 is a perspective view of the lumbar support and vibration generator as seen from a rear.

FIG. 24 is a perspective view of a conveyance seat of a seventh embodiment.

FIG. 25 is a perspective view of a conveyance seat of an eighth embodiment.

FIG. 26 is a cross-sectional view taken along line XXVI-XXVI of FIG. 25.

FIG. 27 is a cross-sectional view taken along line XXVII-XXVII of FIG. 26.

FIG. 28 is a perspective view of a conveyance seat of a ninth embodiment.

FIG. 29 is an exploded perspective view of a second pad material and a vibration generator.

FIG. 30 is an exploded perspective view of a first pad material, the second pad material, and the vibration generator.

FIG. 31A is a plan view of a seat cushion, and is a diagram illustrating the first pad material, the second pad material, and the vibration generator.

FIG. 31B is Modification Example 1 of an attachment structure of the vibration generator.

FIG. 32A is Modification Example 2 of an attachment structure of the vibration generator.

FIG. 32B is Modification Example 3 of an attachment structure of the vibration generator.

FIG. 32C is Modification Example 4 of an attachment structure of the vibration generator.

FIG. 33 is a perspective view of a conveyance seat of a tenth embodiment.

FIG. 34 is a plan view of a seat cushion, and is a diagram illustrating a first pad material, a second pad material, and a vibration generator.

FIG. 35 is a cross-sectional view taken along line XXXV-XXXV of FIG. 34.

FIG. 36A is Modification Example 5 of an attachment structure of the vibration generator.

FIG. 36B is Modification Example 6 of an attachment structure of the vibration generator.

FIG. 37 is a perspective view of a conveyance seat of an eleventh embodiment.

FIG. 38A is a side sectional view of a seat cushion.

FIG. 38B is a side sectional view of the seat cushion, and is a diagram illustrating a state in which a cushion airbag device is bulged and deployed.

FIG. 39 is a perspective view of a conveyance seat of a twelfth embodiment.

FIG. 40 is a plan view of a pad material of a seat cushion.

FIG. 41 is a cross-sectional view taken along line XLI-XLI of FIG. 40, and is a diagram illustrating arrangement of a vibration generator.

FIG. 42A is Modification Example 1 of an arrangement pattern of the vibration generator.

FIG. 42B is Modification Example 2 of an arrangement pattern of the vibration generator.

FIG. 43 is a perspective view of a conveyance seat of a thirteenth embodiment.

FIG. 44 is a cross-sectional view of a pad material of a seat cushion, and is a diagram illustrating arrangement of a vibration generator and an air conditioner.

FIG. 45 is a modification example of an arrangement pattern of the vibration generator and the air conditioner.

FIG. 46 is a perspective view of a conveyance seat of a fourteenth embodiment.

FIG. 47 is a plan view of a pad material of a seat cushion, and is a diagram illustrating a seat heater and a vibration generator.

FIG. 48 is a modification example of an arrangement pattern of the seat heater and the vibration generator.

FIG. 49 is a perspective view of a conveyance seat of a fifteenth embodiment.

FIG. 50 is a front view of a back frame, and is a diagram illustrating a positional relationship between a vibration generator and a pressure receiving plate.

### DESCRIPTION OF EMBODIMENTS

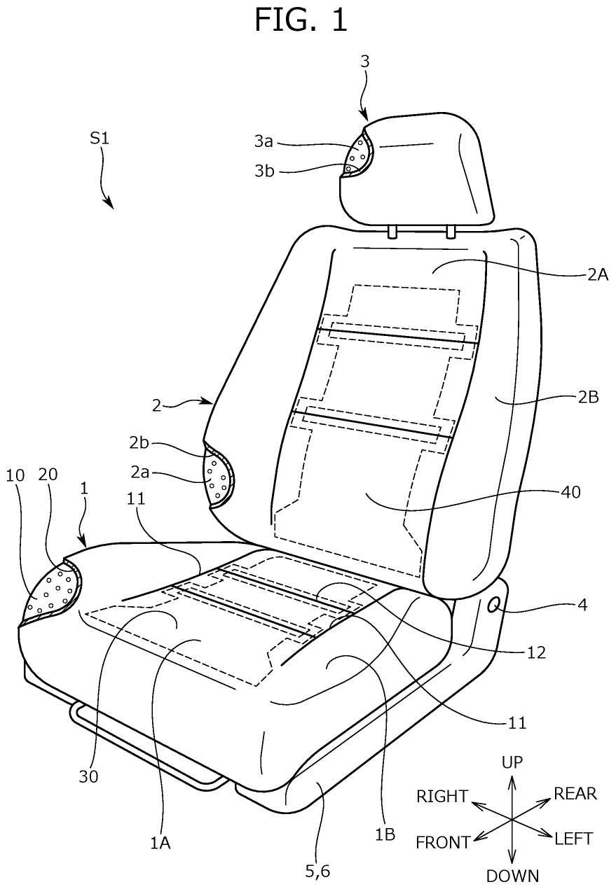

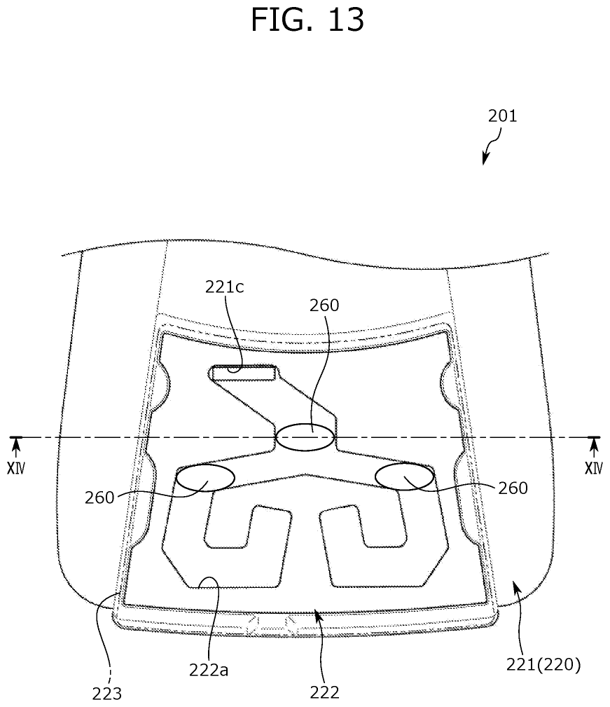

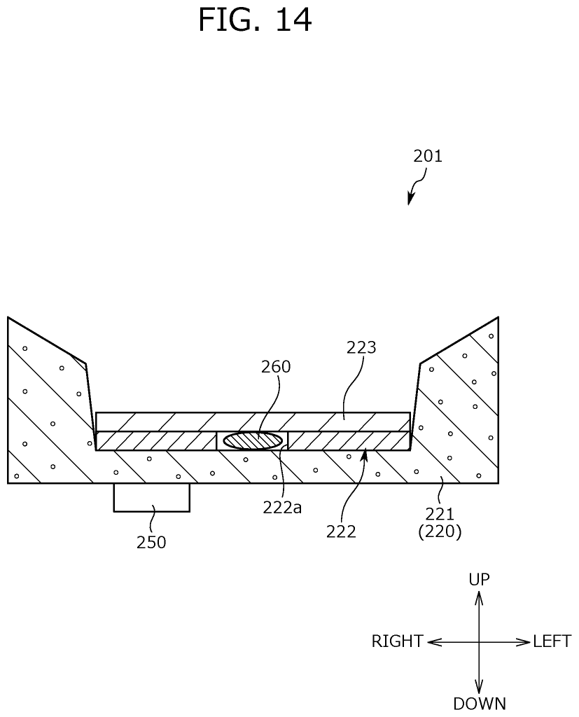

Embodiments according to the invention will be described below with reference to FIGS. 1 to 50.

The embodiment is a conveyance seat including a sheet-shaped seat heater between a pad material and a skin material, and relates to a conveyance seat mainly characterized in that the pad material has pull-in grooves provided to divide a surface of the pad material into a first pad portion and a second pad portion and used to pull in a skin end portion of the skin material, the seat heater has a first heater portion disposed on a surface of the first pad portion, a second heater portion disposed on a surface of the second pad portion, and heater connecting portions disposed to straddle the pull-in grooves to connect the first heater portion and the second heater portion, and the heater connecting portions are attached to the skin end portion of the skin material and have portions pulled into the pull-in grooves together with the skin end portion.

Note that a side where a seated occupant sits on a seat back of the conveyance seat is a front side of the seat.

### First Embodiment

First, a conveyance seat S1 of a first embodiment will be described based on FIGS. 1 to 9.

As illustrated in FIG. 1, the conveyance seat S1 is a vehicle seat and mainly includes a seat body having a seat cushion 1, a seat back 2, and a headrest 3, and sheet-shaped seat heaters 30 and 40 attached inside the seat cushion 1 and the seat back 2, respectively.

Note that the seat heaters 30 and 40 are connected to a power supply and a control device via harnesses.

As illustrated in FIGS. 1 to 4, the seat cushion 1 is a seating portion that supports the occupant from below, and is configured by placing a pad material 10 on a cushion frame (not illustrated) serving as a skeleton and covering the pad material with a skin material 20.

The seat cushion 1 includes a central portion 1A located in a central part in a seat width direction, and right and left side portions 1B (side bolster portions) located outside the central portion 1A in the seat width direction.

The cushion frame is made of a rectangular frame-shaped body, and mainly includes side frames disposed on the right and left sides, a plate-shaped pan frame bridged in a front portion of each side frame, a rear connecting frame connecting a rear portion of each side frame, and a plurality of elastic springs (elastic support members) hooked to the pan frame and the rear connecting frame and extending in a serpentine shape in the seat front to the rear direction.

As illustrated in FIG. 1, the seat back 2 is a backrest portion that supports a back of the seated occupant from behind, and is configured by placing a pad material 2a on a back frame (not illustrated) serving as a skeleton and covering the pad material 2a with a skin material 2b.

The seat back 2 includes a central portion 2A located in the central part in the seat width direction, and right and left side portions 2B (side bolster portions) located outside the central portion 2A in the seat width direction.

The back frame is made of a rectangular frame-shaped body, and mainly includes back side frames disposed on the right and left sides, an upper frame having an inverted U shape and connecting an upper end portion of each of the back side frames, a lower frame having a plate shape and connecting a lower end portion of each of the back side frames, a plurality of wire members (elastic wires), each of which is hooked to each back side frame, and a support plate held by the plurality of wire members to support the seated occupant.

Note that a reclining device 4 is attached to a connecting portion of the seat cushion 1 and the seat back 2, and a rail device 6 is attached to a lower portion of the seat cushion 1 via a height link device 5.

As illustrated in FIG. 1, the headrest 3 is a head portion that supports a head of the occupant from behind, and is configured by placing a pad material 3a on a pillar (not illustrated) serving as a core material and covering the pad material 3a with a skin material 3b.

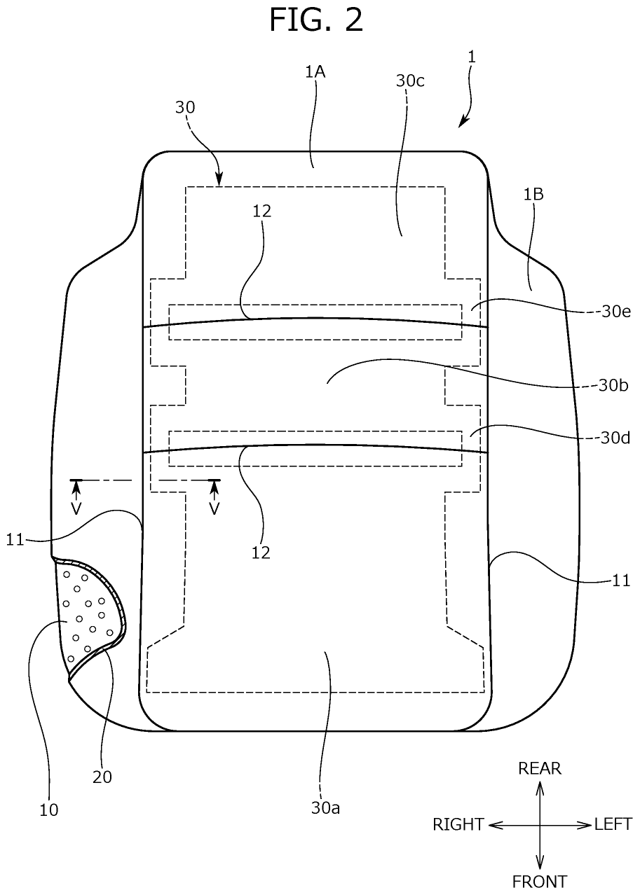

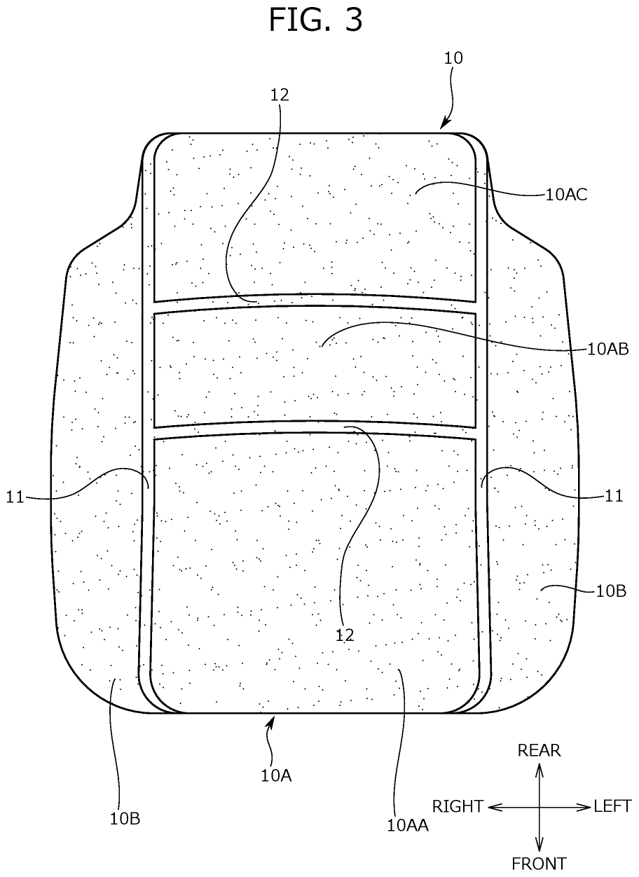

As illustrated in FIGS. 2 and 3, for example, the pad material 10 of the seat cushion 1 is a cushioning material made of urethane foam, etc.

The pad material 10 has first pull-in grooves 11 and second pull-in grooves 12 formed on a surface of the pad material 10 and used to pull in a skin end portion 20a of the skin material 20.

The first pull-in grooves 11 are formed on the right and left sides of the pad material 10 in the seat width direction, and extend in an elongated manner in the seat front to the rear direction.

The right and left first pull-in grooves 11 are disposed to divide the pad material 10 into a central pad portion 10A and side pad portions 10B located outside the central pad portion 10A.

A plurality of second pull-in grooves 12 is formed in the central part of the pad material 10 in the seat width direction, and each of the second pull-in grooves 12 extends in the seat width direction in an elongated manner.

The plurality of second pull-in grooves 12 is disposed to divide the central pad portion 10A into a first central pad portion 10AA, a second central pad portion 10AB, and a third central pad portion 10AC in the seat front to rear direction.

The plurality of second pull-in grooves 12 extends to connect the right and left first pull-in grooves 11.

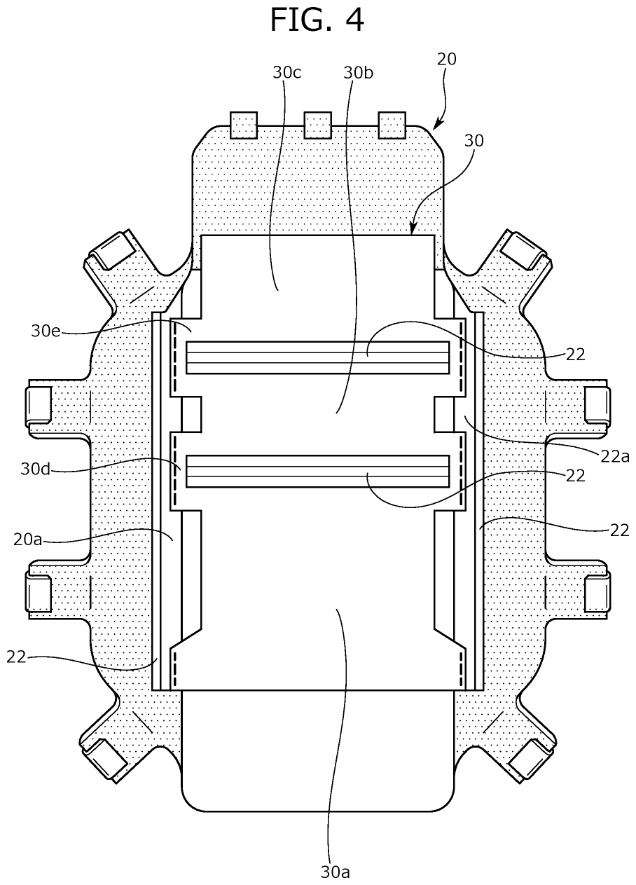

As illustrated in FIGS. 2 and 4, for example, the skin material 20 is made of a stretchable nylon material, etc., and is formed in a shape that allows the pad material 10 to be covered from above.

Specifically, the skin material 20 is divided at positions corresponding to the central pad portion 10A and the right and left side pad portions 10B, and skin end portions 20a of the divided skin material 20 are sewn and connected inside the first pull-in grooves 11.

Further, the skin material 20 is further divided at positions corresponding to the first central pad portion 10AA, the second central pad portion 10AB, and the third central pad portion 10AC, and skin end portions 20a of the divided skin material 20 are sewn and connected inside the second pull-in grooves 12.

A cotton-shaped slab material 21 (wadding material) is sewn and attached to substantially the entire surface on a back surface of the skin material 20 at positions corresponding to the central pad portion 10A and the right and left side pad portions 10B.

Further, a pull-in member 22 is attached to the back surface of the skin material 20 at a position corresponding to the skin end portion 20a along an extending direction of the skin end portion 20a.

Furthermore, a seat heater 30 is attached to a back surface of the central pad portion 10A of the skin material 20.

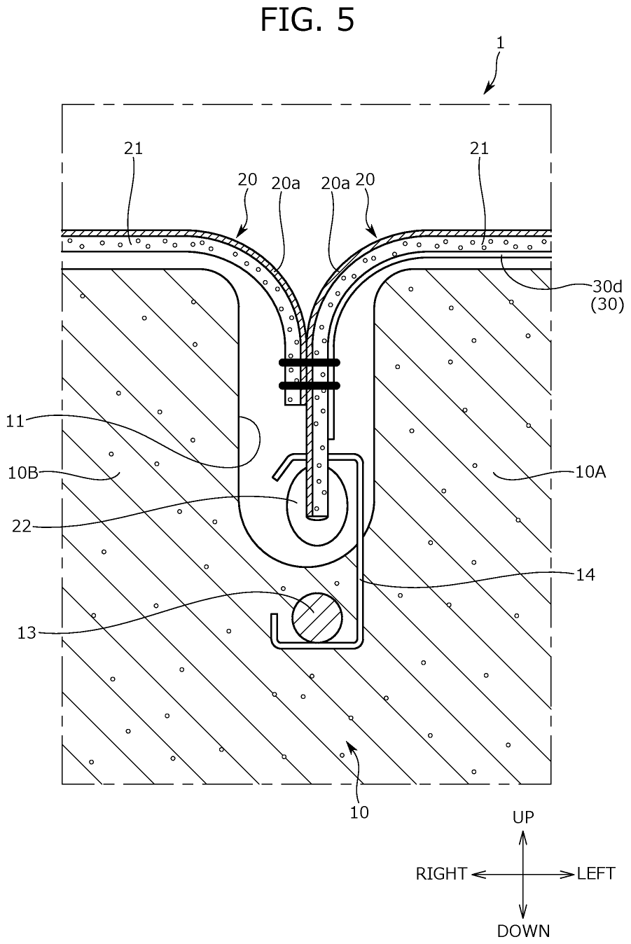

As illustrated in FIGS. 2 and 5, for example, the pull-in member 22 is a resin trim cord, is disposed at a position facing each of the pull-in grooves 11 and 12 of the pad material 10, and extends along an extending direction of each of the pull-in grooves 11 and 12.

The pull-in member 22 is pulled into each of the pull-in grooves 11 and 12 together with the skin end portion 20a.

Specifically, as illustrated in FIG. 5, an elongated insert wire 13 having a circular cross section is embedded at a position below each of the pull-in grooves 11 and 12 of the pad material 10. The insert wire 13 extends along each of the pull-in grooves 11 and 12.

The insert wire 13 and the pull-in member 22 provided at the skin end portion 20a are hooked and connected by an elongated C-ring 14 having a substantially C-shaped cross section.

In this way, the skin end portion 20a of the skin material 20 is pulled into each of the pull-in grooves 11 and 12 of the pad material 10.

### Shape and Arrangement of Seat Heater

As illustrated in FIGS. 1, 2, and 4, the seat heater 30 is a planar heating element that warms the seat cushion 1, attached inside the seat cushion 1, disposed between the pad material 10 and the skin material 20, and attached to the back surface of the skin material 20.

As illustrated in FIG. 1, the seat heater 40 is a planar heating element that warms the seat back 2, and attached inside the seat back 2, disposed between the pad material 2a and the skin material 2b, and attached to the back surface of the skin material 2b.

Since the seat heater 30 and the seat heater 40 have similar configurations, the seat heater 30 will be described in detail below.

The seat heater 30 includes a first heater portion 30a disposed on a surface of the first central pad portion 10AA, a second heater portion 30b disposed on a surface of the second central pad portion 10AB, and a third heater portion 30c disposed on a surface of the third central pad portion 10AC.

In addition, the seat heater is disposed to straddle the pull-in grooves 12, and further includes right and left first heater connecting portions 30d connecting the first heater portion 30a and the second heater portion 30b, and right and left second heater connecting portions 30e connecting the second heater portion 30b and the third heater portion 30c.

The right and left first heater connecting portions 30d and the right and left second heater connecting portions 30e are formed to be narrower than the first heater portion 30a and the second heater portion 30b, respectively.

The first heater portion 30a, the second heater portion 30b, and the third heater portion 30c are disposed at positions facing a portion of the seat cushion 1 in contact with the occupant (specifically, the central part in the seat width direction) when the occupant sits on the seat body, and are disposed at positions not facing the first pull-in grooves 11 and the second pull-in grooves 12.

The right and left first heater connecting portions 30d and the right and left second heater connecting portions 30e are disposed on the right and left sides in the seat width direction, respectively, and are disposed outside of the heater portions 30a, 30b, and 30c in the seat width direction.

Further, the right and left first heater connecting portions 30d and the right and left second heater connecting portions 30e are disposed at overlapping positions (specifically, at the same position), respectively, in the seat front to rear direction.

The first heater connecting portion 30d and the second heater connecting portion 30e are disposed side by side in the seat front to rear direction.

As illustrated in FIG. 4, the heater portions 30a, 30b, and 30c of the seat heater 30 are attached to the back surface of the skin material 20 using an adhesive, etc.

As illustrated in FIGS. 4 and 5, the heater connecting portions 30d and 30e are attached to the skin end portion 20a of the skin material 20 by sewing. Specifically, outer end portions of the heater connecting portions 30d and 30e in the seat width direction are attached to the skin end portion 20a by sewing.

Specifically, as illustrated in FIG. 4, the heater connecting portions 30d and 30e are disposed at positions overlapping with end portions of the second pull-in grooves 12 in the seat width direction.

Further, as illustrated in FIG. 5, portions (outer end portions) of the heater connecting portions 30d and 30e are pulled into the first pull-in grooves 11 and fixed together with the skin end portion 20a of the skin material 20.

According to the above configuration, it is possible to streamline an operation of attaching the seat heater 30 inside the seat cushion 1.

Specifically, the right and left heater connecting portions 30d and 30e are attached to the skin end portion 20a of the skin material 20 by sewing, and pulled into the first pull-in grooves 11 together with the skin end portion 20a. Therefore, an operation process of pushing the heater connecting portions 30d and 30e into the first pull-in grooves 11 as in the past becomes unnecessary. That is, by pulling the skin end portion 20a into the pull-in grooves 11, the heater connecting portions 30d and 30e are also pulled in at the same time. Therefore, it becomes possible to efficiently attach the seat heater 30 (heater connecting portions 30d and 30e).

Further, according to the above configuration, when the skin material 20 is attached to a predetermined position of the pad material 10, an attachment position of the seat heater 30 is also determined. Therefore, an operation of attaching the skin material 20 and the seat heater 30 to the pad material 10 is improved.

### Configuration of Seat Heater

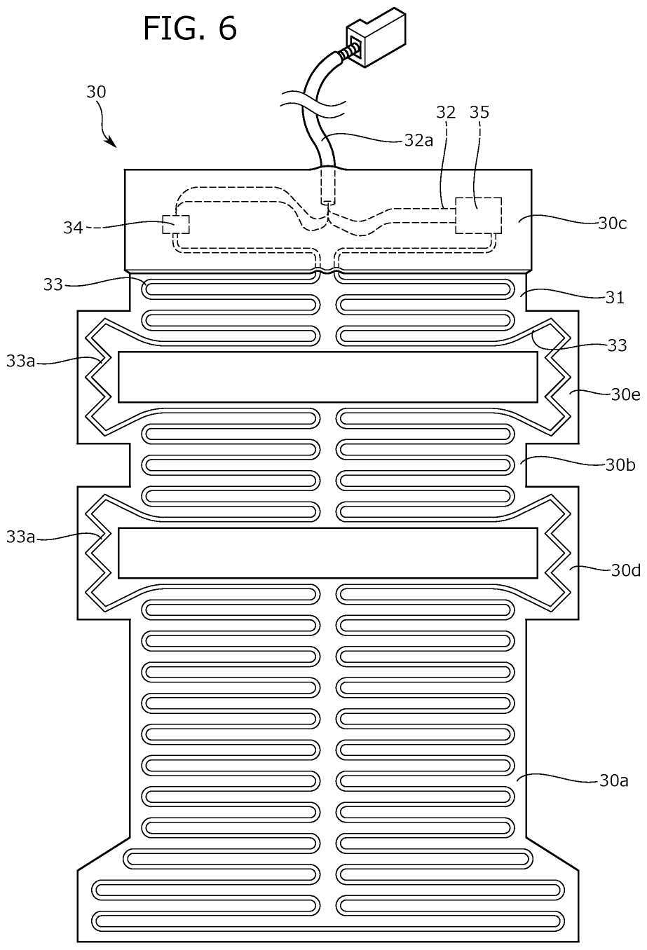

As illustrated in FIG. 6, the seat heater 30 mainly includes a sheet-shaped seat base material 31, electric wires 32 each attached onto the seat base material 31 and connected to a power supply (not illustrated), a heater wire 33 connected to the electric wires 32, and a temperature measurement sensor 34 and a temperature adjustment device 35 connected to the electric wires 32 and the heater wire 33.

The seat base material 31 is made of a stretchable cloth material and is a base portion of the seat heater 30.

The electric wires 32 supply electricity from the power supply to the heater wire 33, the temperature measurement sensor 34, and the temperature adjustment device 35, and a harness 32a is formed by bundling a plurality of electric wires 32 at one end portion thereof.

One end portion of the harness 32a is attached onto the seat base material 31, and the other end portion thereof extends to protrude from the seat base material 31, and is connected to the power supply and the control device.

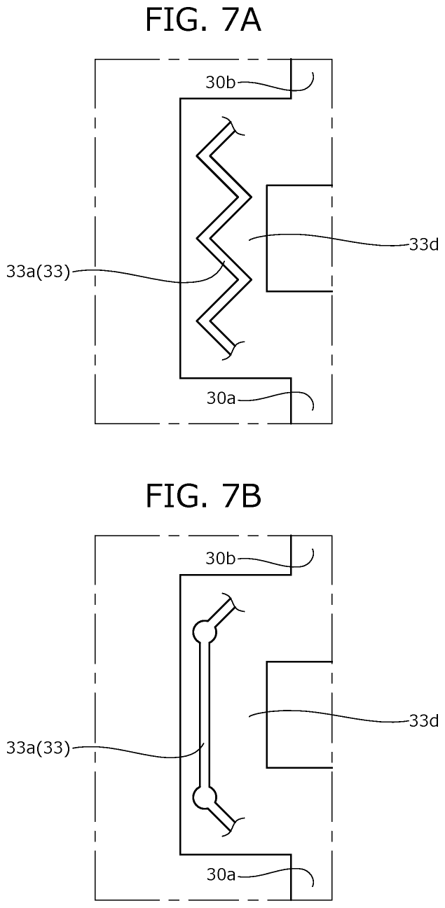

As illustrated in FIGS. 6 and 7A, the heater wire 33 is fixed onto the seat base material 31 using an adhesive. Note that the heater wire 33 may be attached to the seat base material 31 by sewing, etc.

The heater wire 33 extends in a meandering manner toward a front side from a rear end portion of the seat base material 31, is bent and folded back at a front end portion of the seat base material 31, and extends back to the rear end portion.

In the heater wire 33, a heater wire portion 33a attached to the seat base material 31 of the heater connecting portion 30d (30e) extends along an extending direction of the heater connecting portion 30d, and extends while forming a plurality of bent portions.

Specifically, the heater wire portion 33a extends while forming a zigzag shape along the extending direction of the heater connecting portion 30d.

Note that, as illustrated in FIG. 7B, the heater wire portion 33a may simply extend while forming two bent portions along the extending direction of the heater connecting portion 30d. Alternatively, the heater wire portion 33a may form a plurality of bent portions along the extending direction of the heater connecting portion 30d, and extend while forming a meandering shape.

The temperature measurement sensor 34 is a thermistor that measures a temperature of the heater wire 33, and outputs an output signal based on a measurement result of the heater temperature to the control device.

The temperature adjustment device 35 is a thermal thermostat that adjusts the temperature of the heater wire 33, and cuts off the electricity supply to the heater wire 33 when the heater temperature exceeds a predetermined value, thereby maintaining the heater temperature at a certain level or below.

Note that the control device (not illustrated) corresponds to an ECU (Electronic Control Unit), receives an output signal detected by the temperature measurement sensor 34, and compares the heater temperature with a set value, thereby controlling electricity supply to each heater wire 33 from the power supply.

According to the above configuration, comfort of the occupant seated on the seat body can be improved by the seat heaters 30 and 40 having a simple configuration.

Further, in the seat heater 30, the heater portions 30a, 30b, and 30c are disposed by avoiding the pull-in grooves 11 and 12 of the pad material 10, thereby suppressing deformation of the heater portion, so that a load on the heater portion can be suppressed.

In addition, by ensuring as much area as possible for the heater wire 33 in the heater connecting portions 30d and 30e of the seat heater 30, it is possible to distribute the load when the entire heater wire is viewed.

### Others

In the above embodiment, as illustrated in FIG. 3, the pad material 10 has the first pull-in grooves 11 and the second pull-in grooves 12. However, the invention is not particularly limited, and the pad material 10 may have only the first pull-in grooves 11 or may have only the second pull-in grooves 12. Alternatively, the pad material 10 may have third pull-in grooves extending in a predetermined direction in addition to the first pull-in grooves 11 and the second pull-in grooves 12.

In the above embodiment, as illustrated in FIGS. 2 and 4, the seat heater 30 has the first heater portion 30a, the second heater portion 30b, and the third heater portion 30c. However, the invention is not particularly limited, and the seat heater 30 may have two heater portions or four or more heater portions.

In the above embodiment, as illustrated in FIGS. 2 and 4, the seat heater 30 has the right and left first heater connecting portions 30d. However, the invention is not particularly limited, and the seat heater 30 may have the first heater connecting portion 30d on either side rather than both the right and left sides.

Further, even though the seat heater 30 has the first heater connecting portion 30d and the second heater connecting portion 30e, the invention is not particularly limited, and the seat heater 30 may have one heater portion or three or more heater portions.

In the above embodiment, as illustrated in FIGS. 2 and 4, the right and left heater connecting portions 30d (30e) are partially pulled into the right and left first pull-in grooves 11, respectively. However, the invention is not particularly limited, and the entire right and left heater connecting portions 30d (30e) may be pulled in.

Further, the right and left heater connecting portions 30d (30e) are disposed at overlapping positions in the seat front to rear direction. However, the invention is not particularly limited, and the right and left heater connecting portions 30d (30e) may be disposed at different positions in the seat front to rear direction.

In addition, the first heater connecting portion 30d and the second heater connecting portion 30e are disposed at positions aligned in the seat front to rear direction. However, the invention is not particularly limited, and the first heater connecting portion 30d and the second heater connecting portion 30e may be disposed at positions not aligned in the seat front to rear direction, that is, at different positions in the seat width direction.

In the above embodiment, the conveyance seat S1 includes the seat heaters 30 and 40 inside the seat body. However, the conveyance seat S1 may include a sheet-shaped seating sensor (seating sensor module) or various biosensors (biosensor modules) that detect biological information of the seated occupant instead of the seat heaters 30 and 40. Alternatively, the conveyance seat S1 may include an air cell (air cell module) and an electric product (electric product module) instead.

### Second Embodiment

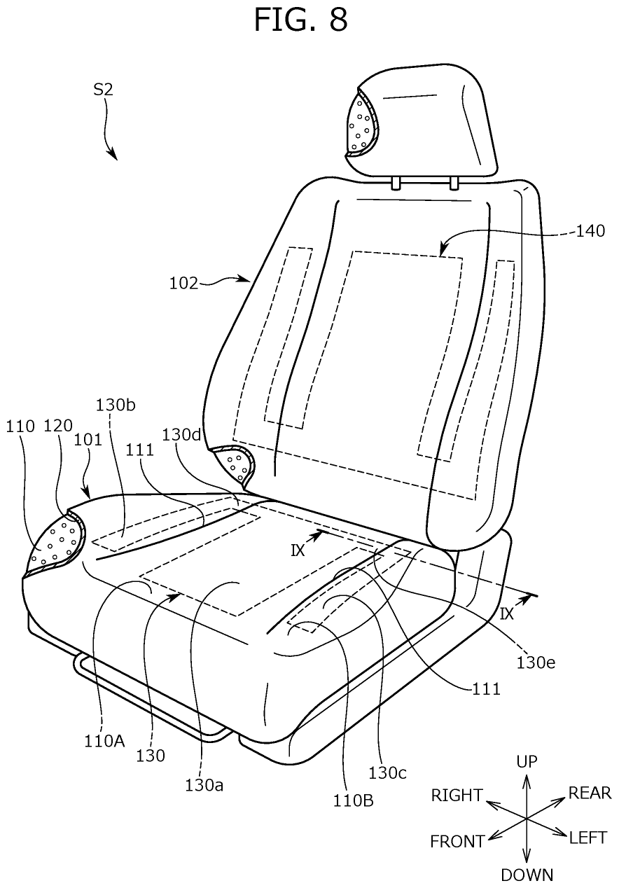

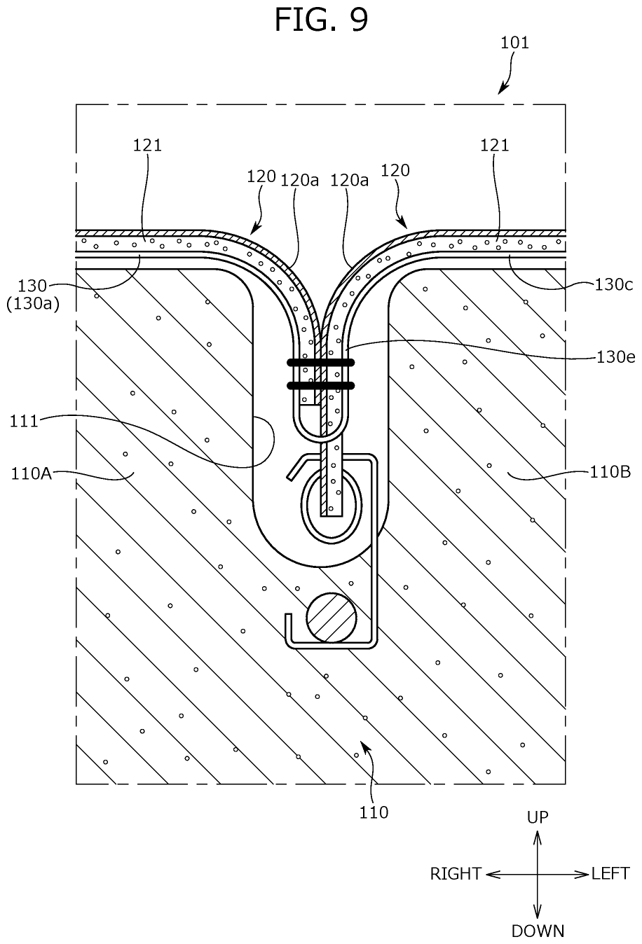

Next, a conveyance seat S2 of a second embodiment will be described based on FIGS. 8 and 9.

Note that description of content that overlaps with the above-mentioned conveyance seat S1 will be omitted.

The conveyance seat S2 includes sheet-shaped seat heaters 130 and 140 attached inside a seat cushion 101 and a seat back 102, respectively.

A pad material 110 of the seat cushion 101 has pull-in grooves 111 each for pulling in a skin end portion 120a of a skin material 120.

The pull-in grooves 111 are formed on the right and left sides of the pad material 110 in the seat width direction, and extend in an elongated manner in the seat front to the rear direction.

The right and left first pull-in grooves 11 are disposed to divide the pad material 110 into a central pad portion 110A and side pad portions 110B located outside the central pad portion 110A.

A seat heater 130 is disposed between the pad material 110 and the skin material 120 and attached to a back surface of the skin material 120.

The seat heater 130 includes a rectangular central heater portion 130a placed on a surface of the central pad portion 110A, L-shaped side heater portions 130b and 130c disposed on surfaces of the right and left side pad portions 110B, and heater connecting portions 130d and 130e that connect the central heater portion 130a and the side heater portions 130b and 130c.

The central heater portion 130a is disposed at a position facing a portion of the seat cushion 1 in contact with the occupant when the occupant sits on the seat body. Further, the central heater portion 130a is disposed at a position not facing the pull-in grooves 111.

The right and left heater connecting portions 130d and 130e are disposed on the right and left sides in the seat width direction, respectively, and are disposed outside the central heater portion 130a in the seat width direction.

Further, the right and left heater connecting portions 130d and 130e are disposed at overlapping positions, respectively, in the seat front to rear direction (specifically, at the same position).

In the seat heater 130, the central heater portion 130a and the side heater portions 130b and 130c are attached to the back surface of the skin material 120 using an adhesive, etc.

The heater connecting portions 130d and 130e are attached to the skin end portion 120a of the skin material 120 by sewing. Specifically, central portions of the heater connecting portions 130d and 130e in the seat width direction are attached to the skin end portion 120a by sewing. Further, the heater connecting portions 130d and 130e are pulled into the pull-in grooves 111 together with the skin end portion 120a and fixed.

The above embodiment can streamline an operation of attaching the seat heaters 130 and 140 inside the seat body.

Specifically, by pulling the skin end portion 120a into the pull-in grooves 111, the heater connecting portions 130d and 130e are also pulled in at the same time. Therefore, it becomes possible to efficiently attach the seat heater 130 (heater connecting portions 130d and 130e).

### Third Embodiment

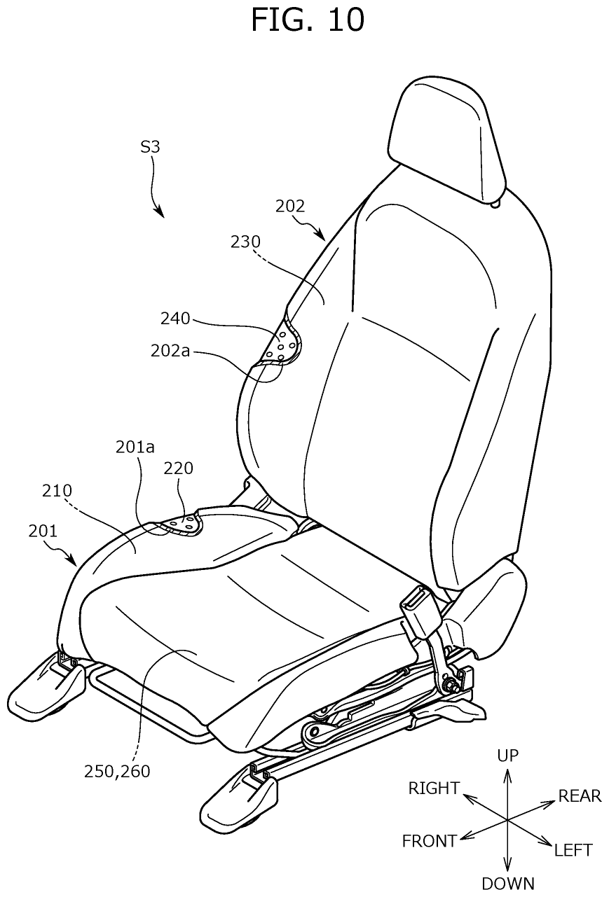

Next, a conveyance seat S3 of a third embodiment will be described based on FIGS. 10 to 16B.

Note that description of content that overlaps with the above-mentioned conveyance seats S1 and S2 will be omitted.

The conveyance seat S3 includes an air blower and a vibration generator inside the seat body, and realizes a seat capable of smoothly operating both the air blower and the vibration generator by devising arrangement layout of the air blower and the vibration generator.

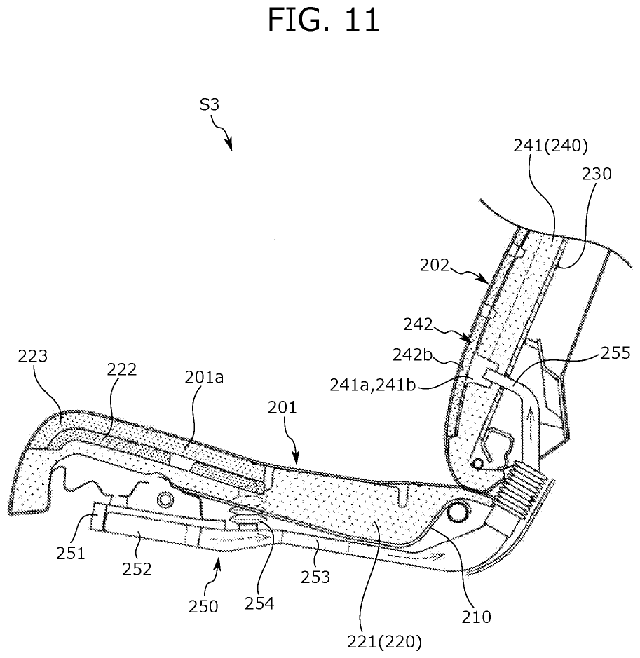

As illustrated in FIGS. 10 and 11, the conveyance seat S3 is a vehicle seat, and includes a seat body having a seat cushion 201 and a seat back 202, an air blower 250 that is attached inside the seat body and blows air toward the seated occupant, and a vibration generator 260 that is attached inside the seat body and applies vibration to the seated occupant.

As illustrated in FIGS. 10 to 12, the seat cushion 201 mainly includes a cushion frame 210, a pad material 220, and a skin material 201a.

The air blower 250 is disposed inside the seat cushion 201.

The seat back 202 mainly includes a back frame 230, a pad material 240, and a skin material 202a.

A component (duct 253) of the air blower 250 is disposed inside the seat back 202.

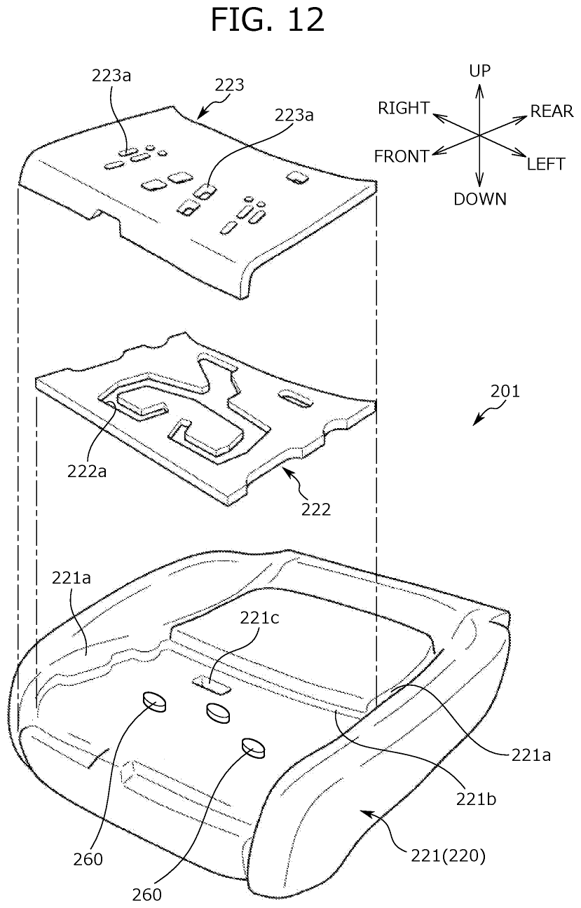

As illustrated in FIGS. 11 and 12, the pad material 220 is a pad stacked body formed by stacking a plurality of pad materials in an up to down direction, and includes a first pad material 221, a second pad material 222 formed to be softer than the first pad material 221, and a third pad material 223 formed to be softer than the first pad material 221.

The second pad material 222 and the third pad material 223 are also referred to as cover materials, are attached to a surface of a central portion of the first pad material 221 in a seat width direction, and cover the central portion of the first pad material 221 from above.

As illustrated in FIG. 12, the first pad material 221 is made of a resin material such as foamed polypropylene.

Right and left first skin pull-in grooves 221a, second skin pull-in grooves 221b connecting the right and left first skin pull-in grooves 221a, and a duct insertion hole 221c through which the duct 253 of the air blower 250 is inserted are formed on a surface of the first pad material 221. The duct insertion hole 221c is a hole having a substantially rectangular cross section, and is formed to penetrate the first pad material 221 in a thickness direction.

The second pad material 222 and the third pad material 223 are made of a resin material such as urethane foam, and are softer than the first pad material 221.

A ventilation passage 222a is formed on a surface of the second pad material 222 to guide air blown out from the duct 253 (blowout portion 254).

The ventilation passage 222a is formed at a position corresponding to (a position facing) the duct insertion hole 221c. Further, the ventilation passage 222a extends toward a front of the seat and sides of the seat while branching. Air is guided through substantially the entire central portion of the seat cushion 201 by the ventilation passage 222a.

A plurality of ventilation holes 223a is formed at positions corresponding to the ventilation passages 222a on a surface of the third pad material 223 at intervals in the seat front to rear direction and the seat width direction. The ventilation holes 223a are disposed at positions not facing the duct insertion hole 221c.

According to the above configuration, air can be blown out favorably toward the seated occupant.

The above description is similarly applied to the pad material 240 of the seat back 202.

As illustrated in FIG. 11, in other words, the pad material 240 is a pad stacked body, and includes a first pad material 241 and a second pad material 242 disposed in front of the first pad material 241 and formed to be softer than the first pad material 241.

A duct insertion hole 241a and a ventilation passage 241b are formed on a surface of the first pad material 241. A plurality of ventilation holes 242b is formed on a surface of the second pad material 242.

As illustrated in FIG. 11, the air blower 250 is attached to a bottom surface of the cushion frame 210 via an attachment bracket 251, and includes a blower 252 that blows out air and a duct 253 that is connected to the blower 252 and allows air to pass through.

The duct 253 extends from the blower 252 toward the rear of the seat, bends around a rear end portion of the seat cushion 201, and further extends upward.

Further, the duct 253 includes a blowout portion 254 that is branched at a predetermined position, extends upward from a branch point, and passes through the pad material 220 of the seat cushion 201, and a blowout portion 255 that extends toward the front of the seat at a tip of the duct and passes through the pad material 240 of the seat back 202.

The blowout portions 254 and 255 are outlets that blow out air toward the seated occupant, and are exposed on surfaces of the pad materials 220 and 240, respectively.

As illustrated in FIGS. 12 to 14, the vibration generator 260 is a vibration motor that applies physical force to the seated occupant, and is, for example, an eccentric motor, a linear vibrator, a piezo element, etc.

A plurality of vibration generators 260 is disposed on a surface of the first pad material 221 of the seat cushion 201, and is attached to the surface of the first pad material 221 using an adhesive, etc.

Further, the vibration generators 260 are disposed to fit inside the ventilation passage 222a formed in the second pad material 222. Furthermore, the vibration generators 260 are covered from above by the third pad material 223.

Note that, even though the vibration generators 260 are attached to the surface of the first pad material 221, the invention is not particularly limited thereto. For example, the vibration generators 260 may be attached directly to the second pad material 222 or may be attached to the second pad material 222 via an attachment member. Alternatively, the vibration generators 260 may be attached to a back surface of the third pad material 223.

### Modification Example 1

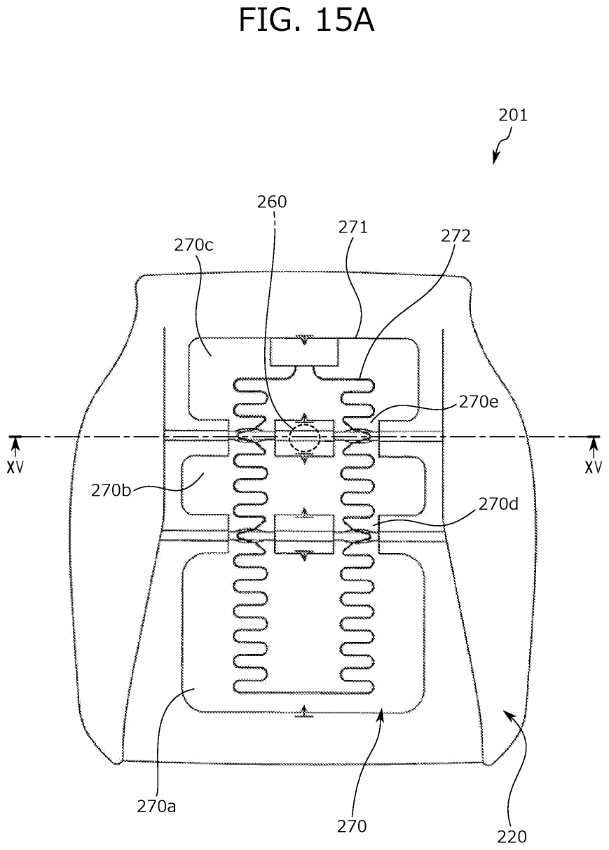

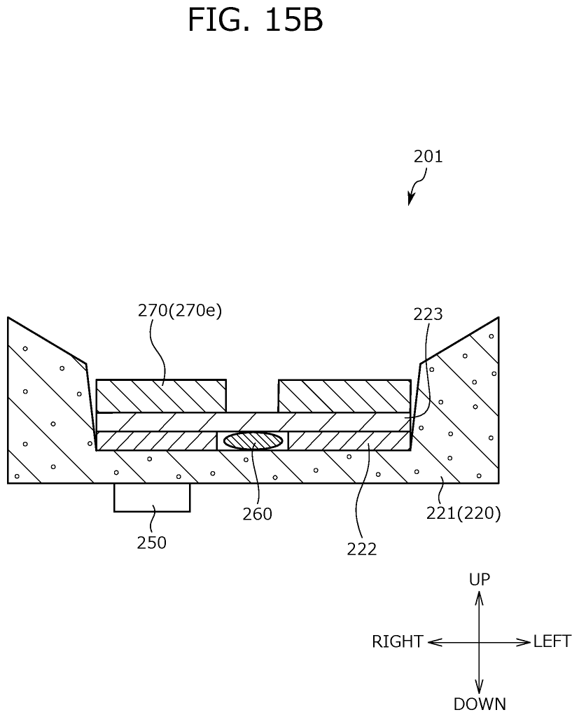

As illustrated in FIGS. 15A and 15B, the conveyance seat S3 may include a seat heater 270.

The seat heater 270 is a planar heating element that warms the seat cushion 201, is attached inside the seat cushion 201, and is disposed between the pad material 220 and the skin material 201a.

The seat heater 270 is attached to a surface of the pad material 220 or a back surface of the skin material 201a.

The seat heater 270 includes a first heater portion 270a, a second heater portion 270b, a third heater portion 270c, right and left first heater connecting portions 270d connecting the first heater portion 270a and the second heater portion 270b, and right and left second heater connecting portions 270e connecting the second heater portion 270b and the third heater portion 270c.

Further, the seat heater 270 includes a sheet-shaped seat base material 271 and a heater wire 272 attached onto the seat base material 271.

In the above configuration, as illustrated in FIG. 15B, the vibration generator 260 is disposed at a position not overlapping with the seat heater 270 on the pad material 220.

In this way, a thickness of the seat cushion 201 can be inhibited from increasing when compared to the case where the vibration generator 260 and the seat heater 270 overlap on the surface of the pad material 220.

### Modification Example 2

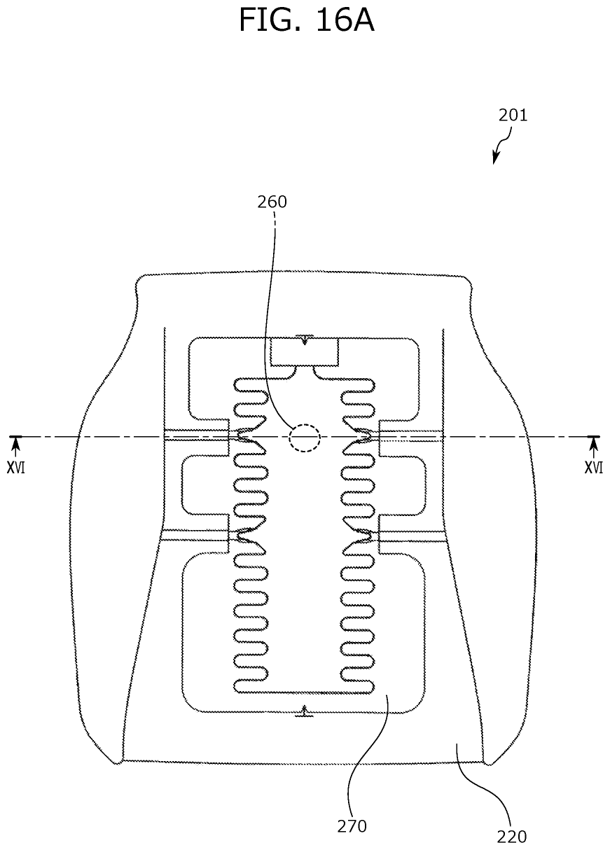

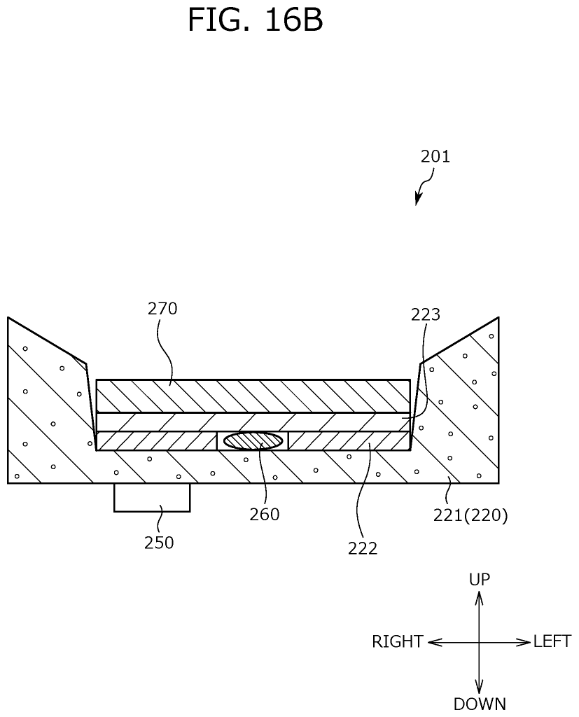

As illustrated in FIGS. 16A and 16B, the conveyance seat S3 may include the seat heater 270.

As illustrated in FIG. 16B, the vibration generator 260 is disposed at a position overlapping the seat heater 270 on the pad material 220. In other words, the vibration generator 260 is covered from above by the seat heater 270.

In this way, it is possible to prevent the seated occupant from feeling a foreign object caused by the vibration generator 260 and impairing a seating feeling.

### Supplementary Note

The conveyance seat of the invention is a conveyance seat including a pad material, a ventilation passage that allows air blown out from an air blower to pass through may be formed in the pad material, and a vibration generator may be disposed at a predetermined position of the ventilation passage.

According to the above configuration, it is possible to form the ventilation passage in the pad material and to suitably dispose the vibration generator.

Further, in the conveyance seat described above, the pad material includes a first pad material and a second pad material disposed on the first pad material and forming the ventilation passage, and the vibration generator may be disposed inside the ventilation passage of the second pad material.

According to the above configuration, since the vibration generator can be disposed inside the ventilation passage, it is possible to suppress an increase in the thickness of the conveyance seat when compared to the case where the vibration generator is disposed on the surface of the pad material.

Furthermore, in the conveyance seat described above, the pad material may further include a third pad material disposed on the second pad material, and the third pad material may be disposed to cover the vibration generator from above.

According to the above configuration, the third pad material can suitably protect the vibration generator.

Further, in the conveyance seat described above, it is preferable that the vibration generator is formed to be narrower than the ventilation passage in the second pad material.

According to the above configuration, it is possible to inhibit the vibration generator from obstructing an air passage.

Further, in the above conveyance seat, it is preferable that the air blower is provided inside the conveyance seat and includes a duct that allows air blown out from the blower to pass through, a duct insertion hole that penetrates the first pad material in the thickness direction and allows the duct to be inserted therethrough is formed in the first pad material, and the vibration generator is disposed on the first pad material and is disposed by avoiding the duct insertion hole.

According to the above configuration, it is possible to inhibit the vibration generator from obstructing an air passage.

Further, in the conveyance seat described above, it is preferable that the conveyance seat includes a seat heater disposed on the surface of the pad material, and the vibration generator is disposed at a position not overlapping with the seat heater on the pad material.

According to the above configuration, an increase in the thickness of the conveyance seat can be suppressed when compared to the case where the vibration generator and the seat heater overlap on the surface of the pad material.

Further, in the conveyance seat described above, it is preferable that the conveyance seat includes a seat heater disposed on the surface of the pad material, and the vibration generator is disposed at a position overlapping with the seat heater on the pad material.

According to the above configuration, it is possible to prevent the seated occupant from feeling a foreign object caused by the vibration generator and impairing a seating feeling.

### Fourth Embodiment

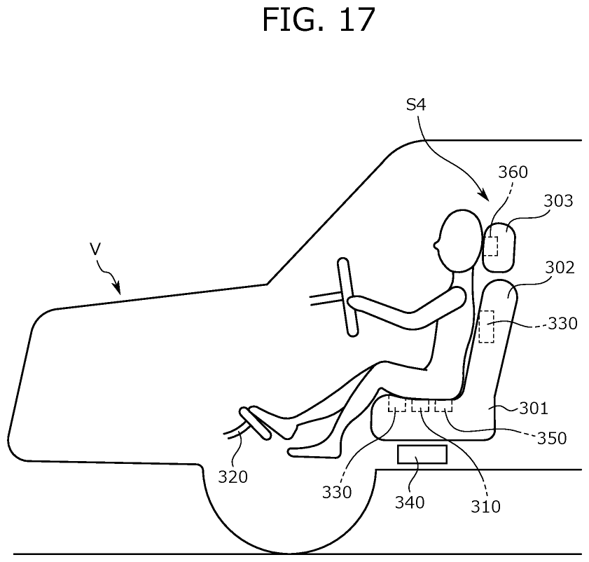

Next, a conveyance seat S4 of a fourth embodiment will be described based on FIG. 17.

Note that description of content that overlaps with the above-mentioned conveyance seats S1 to S3 will be omitted.

The conveyance seat S4 includes a vibration generator inside the seat body, and realizes a seat that can control output of the vibration generator according to a speed of the vehicle and a seated state of the seated occupant.

The conveyance seat S4 is a vehicle seat and includes a seat cushion 301, a seat back 302, and a headrest 303.

In addition, the conveyance seat S4 further includes a seating sensor 310, a vibration generator 330, a control device 340, a weight sensor 350, and a sitting height detection sensor 360.

The seating sensor 310, the control device 340, and the weight sensor 350 are attached inside the seat cushion 301.

The vibration generator 330 is attached inside each of the seat cushion 301 and the seat back 302.

The sitting height detection sensor 360 is attached inside the headrest 303.

In addition, a vehicle speed sensor 320 is attached to a vehicle V.

The control device 340 receives detection signals detected by the sensors 310, 320, 350, and 360, and controls driving of the vibration generator 330 based on the detection signals.

Hereinafter, a plurality of control patterns will be described.

The control device 340 controls output of the vibration generator 330 based on a seated state of the seated occupant detected by the seating sensor 310 and a vehicle speed detected by the vehicle speed sensor 320.

For example, when the vehicle speed is less than 40 km/h as a threshold value, the control device 340 performs a control operation so that output of the vibration generator 330 becomes 50% of an output limit. In particular, when the vehicle is stopped (when the vehicle speed is 0 km/h), a control operation is performed so that output of the vibration generator 330 is more lowered.

For example, when the vehicle speed is greater than or equal to 40 km/h as the threshold value and less than 100 km/h, the control device 340 performs a control operation so that output of the vibration generator 330 becomes 70% of the output limit.

For example, when the vehicle speed is greater than or equal to 100 km/h as a threshold value, the control device 340 performs a control operation so that output of the vibration generator 330 becomes 100% of the output limit.

In general, as the vehicle speed increases, road noise and vehicle body vibration increase, making the seated occupant experience less vibration. Therefore, by increasing the output of the vibration generator 330 in this way, the seated occupant can favorably feel vibration.

Note that when the seating sensor 310 detects that the occupant is not seated (unseated state), the control device 340 preferably performs a control operation so that the vibration generator 330 is not driven.

In this way, it is possible to suppress energy consumption of these electrical components. Moreover, since vibration noise is generated when the vibration generator 330 is driven in the unseated state, generation of the vibration noise can be prevented.

The control device 340 controls output of the vibration generator 330 based on a weight of the occupant detected by the weight sensor 350 and a physique (sitting height) of the occupant detected by the sitting height detection sensor 360.

Specifically, the sitting height detection sensor 360 detects the sitting height of the occupant and calculates a numerical value of the sitting height. Further, the weight sensor 350 detects the weight of the occupant and calculates a numerical value of the weight.

For example, when a numerical value obtained by dividing the sitting height by the weight (a numerical value obtained by sitting height/weight) is greater than a predetermined threshold value, the control device 340 performs a control operation so that output of the vibration generator 330 becomes 100% of the output limit.

For example, when the numerical value obtained by dividing the sitting height by the weight is the same as the predetermined threshold value, the control device 340 performs a control operation so that output of the vibration generator 330 becomes 70% of the output limit.

For example, when the numerical value obtained by dividing the sitting height by the weight is less than the predetermined threshold, the control device 340 performs a control operation so that output of the vibration generator 330 becomes 50% of the output limit.

Note that, when detecting the physique of the occupant and a size of a load loaded on the conveyance seat S4, it is preferable to use other devices in combination.

For example, the weight sensor 350 and a seat position sensor may be combined. Alternatively, a camera, a seat slide memory device that stores a slide position of a seat, an air memory device, an infrared sensor, a body pressure sensor, a capacitance sensor, etc. may be combined.

Note that, when it is determined that a child seat is installed in conveyance seat S4 using these detection sensors and a detection device, or when an awake state of the seated occupant is detected and it is determined that the seated occupant is sleeping, the control device 340 preferably performs a control operation so that the vibration generator 330 is not driven.

<Fifth embodiment>

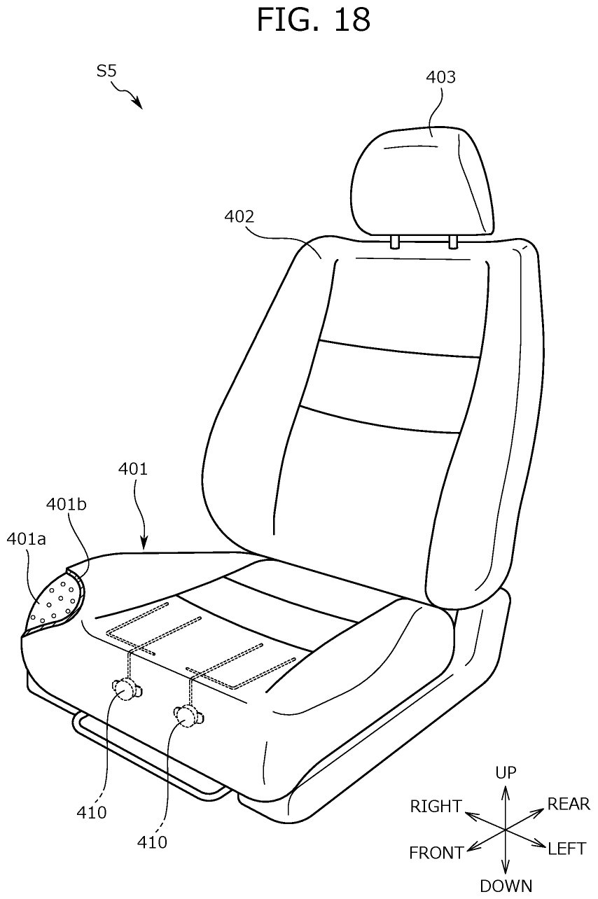

Next, a conveyance seat S5 of a fifth embodiment will be described based on FIGS. 18 to 20B.

Note that description of content that overlaps with the above-mentioned conveyance seats S1 to S4 will be omitted. The conveyance seat S5 includes a vibration generator inside the seat body, and realizes a seat that can vibrate two or more portions by one vibration generator.

The conveyance seat S4 includes a seat cushion 401, a seat back 402, a headrest 403, and a vibration generator 410 provided inside the seat cushion 401.

The vibration generator 410 is disposed between a pad material 401a and a skin material 401b in the seat cushion 401. Specifically, the vibration generator 410 is accommodated in a recess formed on a surface of the pad material 401a. Note that the vibration generator 410 may be embedded inside the pad material 401a. The vibration generator 410 may be provided inside the seat back 402 or the headrest 403.

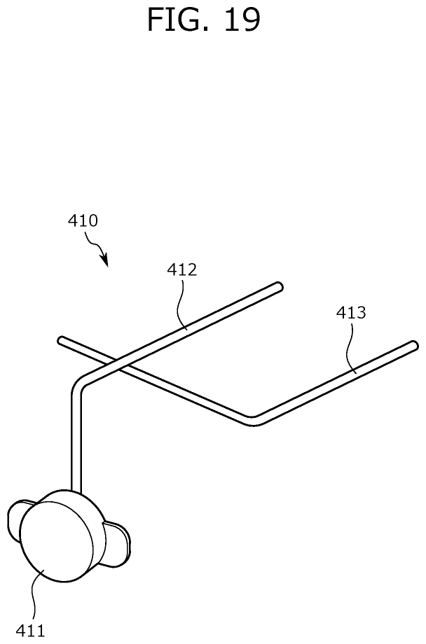

As illustrated in FIG. 19, the vibration generator 410 includes a main body portion 411 (motor portion), a first transmission portion 412 (first transmission wire portion) extending from the main body portion 411, and a second transmission portion 413 (second transmission wire portion) extending from the first transmission portion 412.

The second transmission portion 413 extends to intersect with the first transmission portion 412.

As described above, the first transmission portion 412 and the second transmission portion 413 extend to intersect with each other. Therefore, vibration generated from the main body portion 411 can be propagated to two or more portions by using the transmission portions 412 and 413. In other words, the vibration generator 410 can vibrate two or more portions from one main body portion 411 (motor portion).

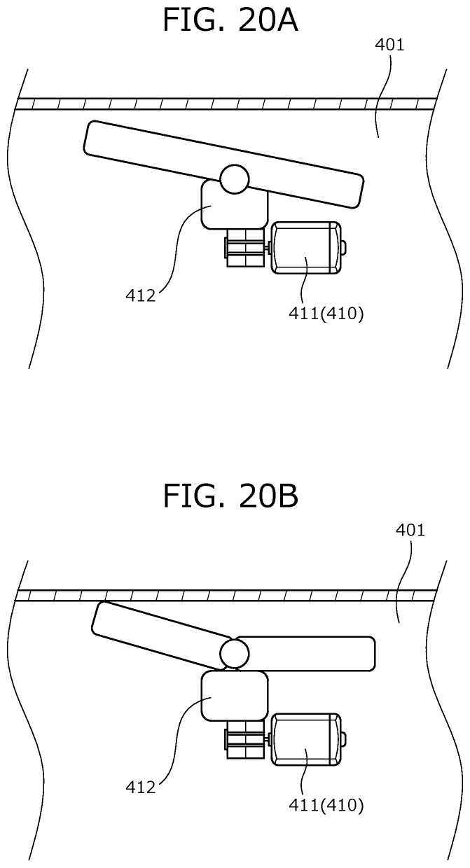

FIG. 20A is Modification Example 1 of the vibration generator 410.

The vibration generator 410 of Modification Example 1 includes a main body portion 411 (motor portion) and a rotary solenoid type transmission portion 412.

In this way, the vibration generator 410 can vibrate two or more portions from one main body portion 411.

FIG. 20B is Modification Example 2 of the vibration generator 410.

The vibration generator 410 of Modification Example 2 includes a main body portion 411 (motor portion) and a rotating gear type transmission portion 412 that can rotate forwardly and reversely.

In this way, the vibration generator 410 can vibrate two or more portions from one main body portion 411.

### Sixth Embodiment

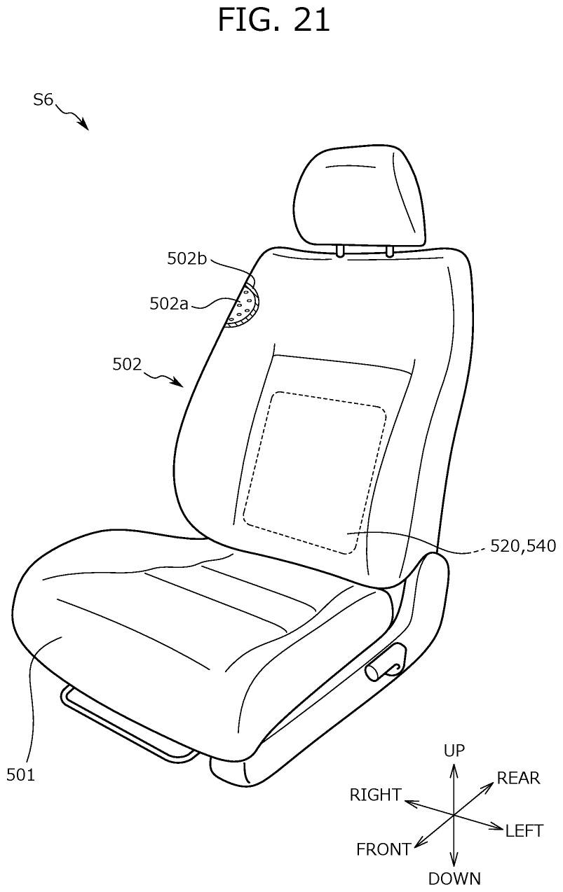

Next, a conveyance seat S6 of a sixth embodiment will be described based on FIGS. 21 to 23.

Note that description of content that overlaps with the above-mentioned conveyance seats S1 to S5 will be omitted.

The conveyance seat S6 includes a lumbar support and a vibration generator inside the seat body, and realizes a seat in which these movable bodies can be suitably disposed.

The conveyance seat S6 includes a seat cushion 501, a seat back 502, a lumbar support 520 attached inside the seat back 502 and movable to project a lower portion of the seat back 502 toward the seated occupant side from a normal position, a driving device 530 (actuator) that drives the lumbar support 520, and a vibration generator 540.

The seat back 502 mainly includes a back frame 510, a pad material 502a placed on the back frame 510, and a skin material 502b covering the back frame 510 and the pad material 502a.

As illustrated in FIG. 22, the back frame 510 includes right and left back side frames 511, an upper frame 512, a lower frame 513, a plurality of wire members 514 each hooked to each of the back side frames 511, and a support plate 515 held by the plurality of wire members 514 to support the seated occupant.

The lumbar support 520 is a member that is disposed in the lower portion of the seat back 502 and supports a lumbar of the seated occupant.

The lumbar support 520 is disposed between the support plate 515 and the pad material 502a, and is a member that is movable to project a central portion of the seat back 502 to the seated occupant side.

Specifically, the lumbar support 520 is a movable plate that is supported on a front surface of the support plate 515 and can be curved to protrude toward a front side of the seat.

When the driving device 530 is driven, the lumbar support 520 bends to warp in the up to down direction, allowing the central portion of the seat back 502 to protrude toward the front side of the seat.

The driving device 530 is an actuator that is fixed to an inner surface of the back side frame 511 and drives the lumbar support 520 to move the lumbar support 520 in the seat front to rear direction and the up to down direction.

The driving device 530 includes a driving main body portion 531 and a plurality of cables 532, 533, and 534 that connects the driving main body portion 531 and the lumbar support 520 and acts to move the lumbar support 520 as the driving main body portion 531 operates.

When the first cable 532 is pulled as the driving main body portion 531 is driven, the lumbar support 520 bends to warp in the up to down direction and moves toward the front side of the seat. Moreover, by releasing pulling of the first cable 532, the lumbar support 520 returns to a flat shape again.

Further, as the driving main body portion 531 is driven, the second cable 533 and the third cable 534 are pulled, so that the lumbar support 520 moves upward. Furthermore, when pulling of the second and third cables 533 and 534 is released, the lumbar support 520 moves downward.

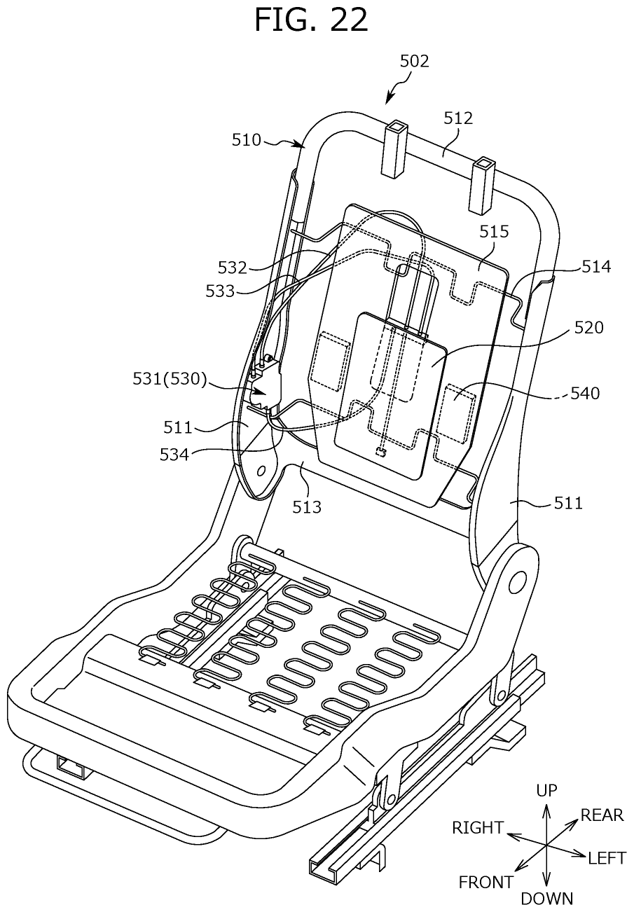

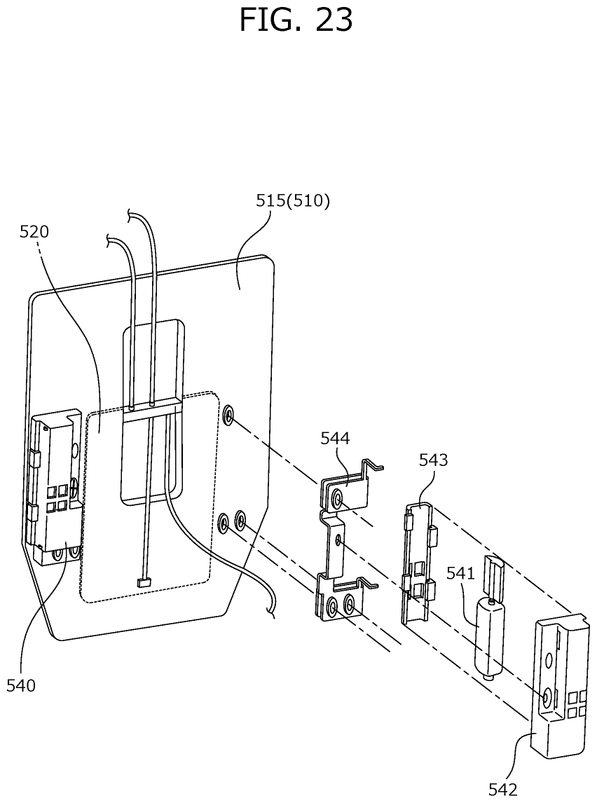

As illustrated in FIG. 23, the vibration generator 540 is a member that is disposed in a lower portion of the seat back 502 and applies vibration to the lumbar of the seated occupant.

The vibration generator 540 is provided on a back surface of the support plate 515 and attached to each of right and left side portions of the support plate 515.

The right and left vibration generators 540 are disposed at positions interposing the lumbar support 520 therebetween in the seat width direction.

The vibration generator 540 includes a main body portion 541 (motor portion), a first case 542 and a second case 543 that accommodate the main body portion 541, and an attachment bracket 544 for attaching the main body portion 541 to the support plate 515.

The main body portion 541 is, for example, an unbalanced mass type motor member.

As mentioned above, the lumbar support 520 is attached to a central portion of a back surface of support plate 515. Further, the right and left vibration generators 540 are attached to right and left side portions of the back surface of the support plate 515 and are disposed at different positions from the lumbar support 520.

In this way, the movable bodies 520 and 540 can be suitably disposed without affecting movement of the lumbar support 520 and the vibration generator 540.

### Seventh Embodiment

Next, a conveyance seat S6 of a seventh embodiment will be described based on FIG. 24.

Note that description of content that overlaps with the above-mentioned conveyance seats S1 to S6 will be omitted.

The conveyance seat S7 includes different types of vibration generators inside the seat body, and realizes a seat capable of applying vibration to the seated occupant by suitably disposing these vibration generators.

The conveyance seat S7 includes a seat cushion 601, a seat back 602, a first vibration generator 610 attached inside each of the seat cushion 601 and the seat back 602, and a second vibration generator 620 attached inside the seat back 602.

Furthermore, the conveyance seat S7 further includes a control device 630 that controls these vibration generators 610 and 620.

The first vibration generator 610 is a vibration motor that applies physical force to the seated occupant, and is, for example, an eccentric motor.

The second vibration generator 620 is a vibration motor different from the first vibration generator 610, and is, for example, a linear vibrator or a piezo element.

As illustrated in FIG. 24, the first vibration generator 610 is disposed at each of right and left side portions at a front position of the seat cushion 601, a central portion at a rear position of the seat cushion 601, and right and left side portions at an upper position of the seat back 602.

The second vibration generator 620 is disposed at each of right and left side portions at a lower position of the seat back 602.

The vibration generators 610 and 620 are connected to the control device 630 by wireless communication.

By separately disposing the vibration generators 610 and 620 in this way, arrangement layout of the vibration generators 610 and 620 becomes favorable.

According to the above configuration, the vibration generators 610 and 620 can apply different vibrations to the seated occupant.

For example, when it is determined that there is a possibility of a traffic accident based on data communication with the vehicle, the control device 630 preferably operates all the vibration generators 610 and 620 and transmits an alert to the seated occupant.

For example, when it is determined that another vehicle approaches from behind the vehicle, the control device 630 preferably operates at least the second vibration generator 620, which has a stronger vibration force than that of the first vibration generator 610.

For example, when there is desire for synchronization with music playing in the vehicle, the control device 630 preferably operates at least the second vibration generator 620 capable of applying finer vibration than that of the first vibration generator 610.

### Eighth Embodiment

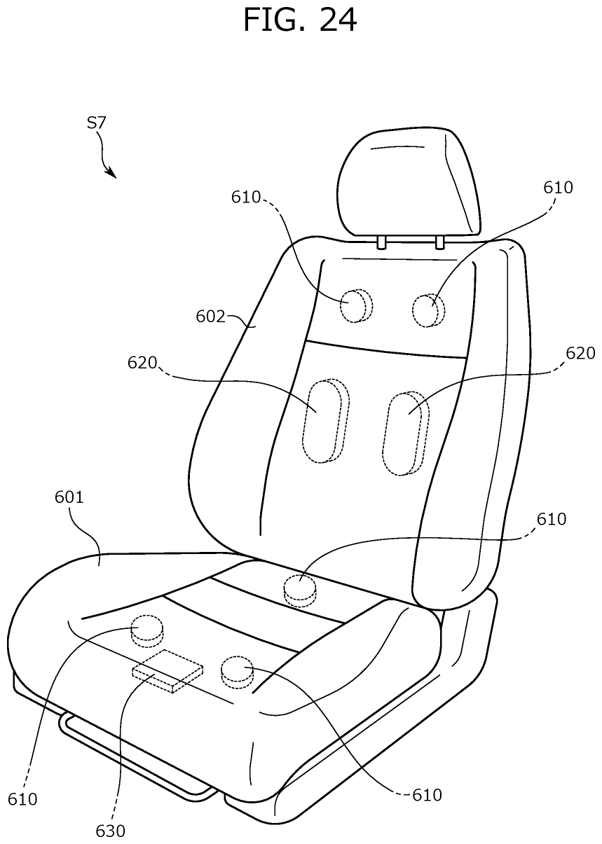

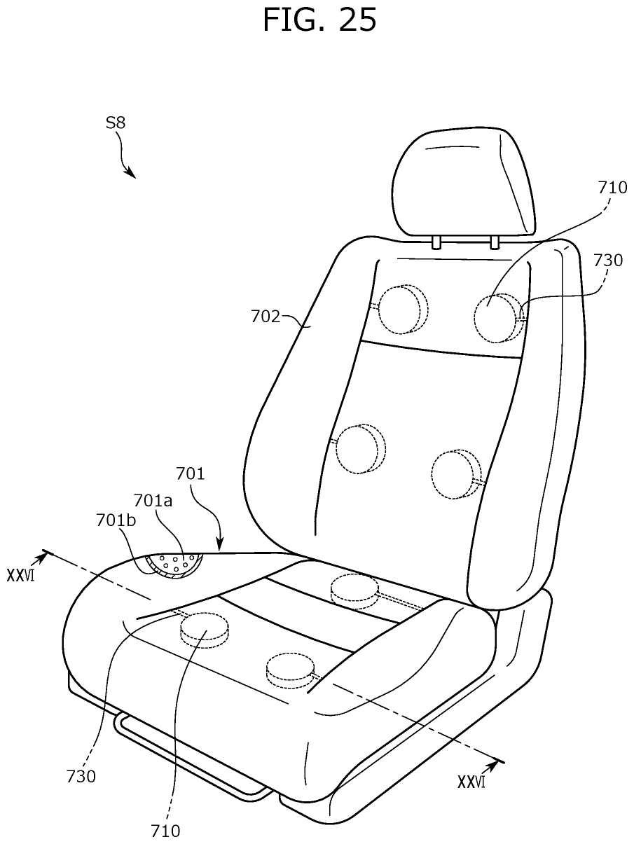

Next, a conveyance seat S8 of an eighth embodiment will be described based on FIGS. 25 to 27.

Note that description of content that overlaps with the above-mentioned conveyance seats S1 to S7 will be omitted.

The conveyance seat S8 includes a vibration generator and a harness inside a seat body, and realizes a seat in which the harness can be suitably arranged.

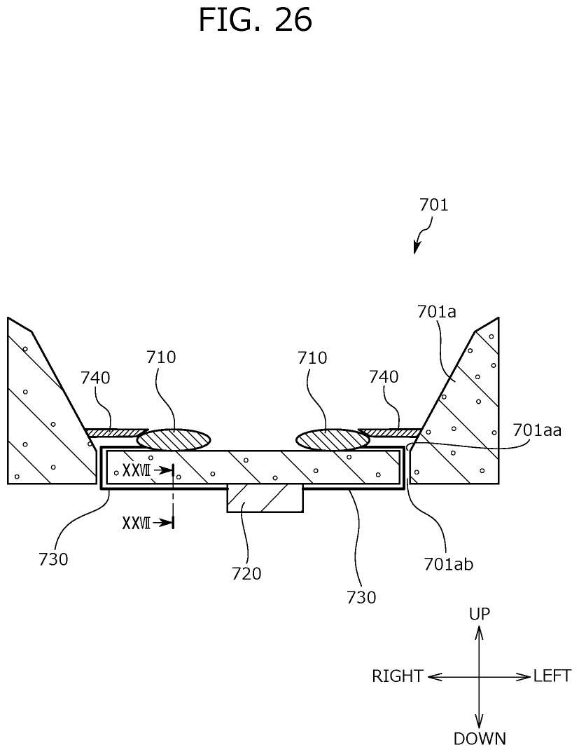

As illustrated in FIGS. 25 and 26, the conveyance seat S8 includes a seat cushion 701, a seat back 702, a vibration generator 710 attached inside each of the seat cushion 701 and the seat back 702, a control device 720 that controls the vibration generator 710, and a harness 730 that electrically connects the vibration generator 710 and the control device 720.

The seat cushion 701 includes a pad material 701a and a skin material 701b covering the pad material 701.

Right and left skin pull-in grooves 701aa and through holes 701ab that are provided at predetermined positions of the right and left skin pull-in grooves 701aa and penetrate the pad material 701a are formed in the pad material 701a.

As illustrated in FIG. 25, the vibration generator 710 is disposed at each of right and left side portions at a front position of the seat cushion 701, and a central portion at a rear position of the seat cushion 701.

In addition, the vibration generator 710 is disposed at each of right and left side portions at an upper position of the seat back 602 and right and left side portions at a lower position of the seat back 602.

As illustrated in FIG. 26, the vibration generator 710 is attached to a surface (upper surface) of the pad material 701a. Meanwhile, the control device 720 is attached to a back surface (bottom surface) of the pad material 701a.

The control device 720 is disposed between the right and left vibration generators 710 in the seat width direction.

As illustrated in FIG. 26, the harness 730 extends from the vibration generator 710 outward in the seat width direction, bends downward, passes through a through-hole 701ab of the pad material 701a, bends inward in the seat width direction on a back surface of the pad material 701a, extends inward in the seat width direction, and is connected to the control device 720.

In the above description, as illustrated in FIG. 26, a protection member 740 that covers the harness 730 from above is preferably provided between the pad material 701a and the skin material 701b in a portion corresponding to (a portion facing) the harness 730.

For example, the protection member 740 is preferably made of cloth, Volans, nonwoven fabric, etc.

In this way, the harness 730 can be suitably protected when the seated occupant is seated.

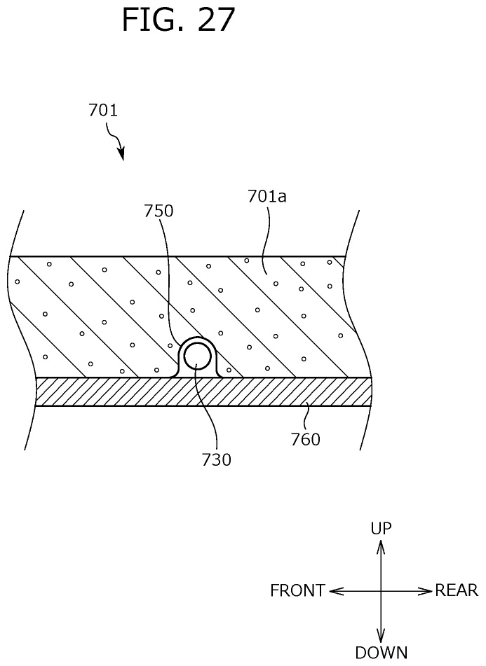

Further, in the above description, as illustrated in FIG. 27, a harness accommodation groove 750 is preferably formed in a portion corresponding to the harness 730 on the back surface of the pad material 701a.

The harness accommodation groove 750 is a groove extending in the seat width direction.

In this way, the harness 730 can be suitably arranged.

Note that a second protection member 760 is preferably provided on the back surface of the pad material 701a in a portion corresponding to the harness accommodation groove 750.

### Ninth Embodiment

Next, a conveyance seat S9 of a ninth embodiment will be described based on FIGS. 28 to 32C.

Note that description of content that overlaps with the above-mentioned conveyance seats S1 to S8 will be omitted.

The conveyance seat S9 includes a vibration generator inside a seat body, and realizes a seat that can suitably apply vibration to the seated occupant while suppressing vibration noise of the vibration generator when compared to conventional ones.

As illustrated in FIG. 28, the conveyance seat S9 includes a seat cushion 801, a seat back 802, and a vibration generator 840 attached inside each of the seat cushion 801 and the seat back 802.

The seat cushion 801 includes a pad material 810 (first pad material) and a skin material 820 that covers the pad material 810.

Note that the seat back 802 also has a similar configuration.

The pad material 810 includes a pad central portion 810A located at a center in the seat width direction, and right and left pad side portions 810B located outside the pad central portion 810A in the seat width direction.

Right and left first skin pull-in grooves 811 that partition the pad central portion 810A and the pad side portions 810B, and a second skin pull-in groove 812 that connects the right and left first skin pull-in grooves 811 are formed on a surface of the pad material 810.

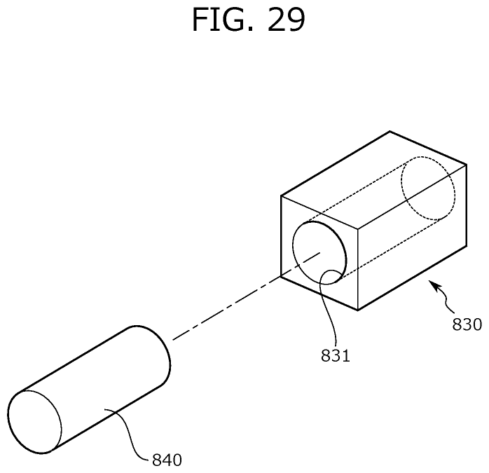

Furthermore, as illustrated in FIGS. 28 and 30, an accommodation recess 813 for accommodating a second pad material 830 is formed in each of right and left side portions of the pad central portion 810A.

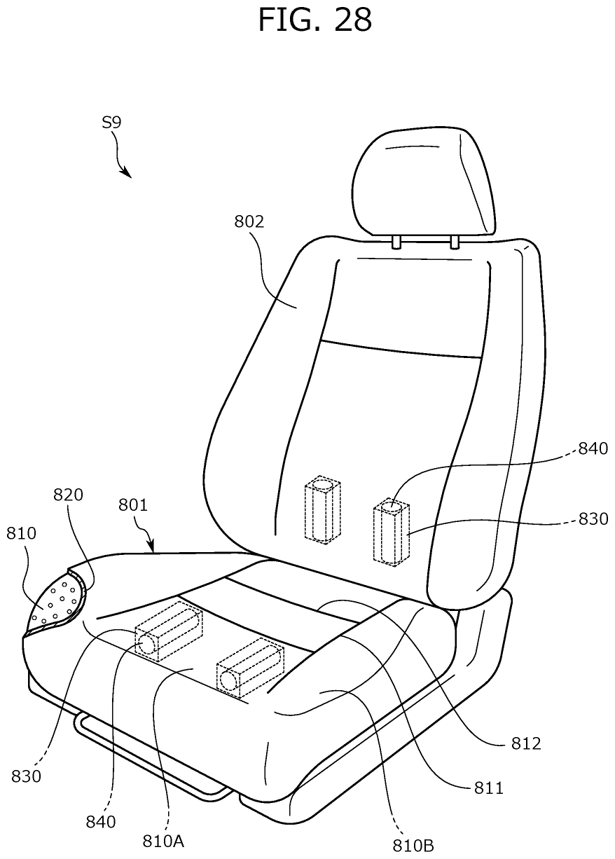

As illustrated in FIG. 29, the second pad material 830 is a rectangular parallelepiped-shaped pad material, and has a size and shape corresponding to the recess-shaped accommodation recess 813.

An accommodation groove 831 for accommodating the vibration generator 840 (vibration motor) is formed on a surface (for example, the front surface) of the second pad material 830.

The accommodation groove 831 is a groove having a size and shape corresponding to, for example, the vibration generator 840 having a substantially cylindrical shape.

When the vibration generator 840 is accommodated in the accommodation groove 831, the vibration generator 840 is attached to the second pad material 830 while being surrounded (wrapped) by the second pad material 830.

Note that the accommodation groove 831 is preferably formed smaller than the vibration generator 840. In this way, the vibration generator 840 can be inhibited from falling out of the second pad material 830.

Specifically, as illustrated in FIG. 30, the accommodation recess 813 of the pad material 810 is formed such that an opening thereof is narrower than a bottom thereof. In other words, the accommodation recess 813 is formed to be wider from the opening toward the bottom.

An outer shape of the second pad material 830 is larger than the accommodation recess 813.

The second pad material 830 is formed so that a surface portion (upper surface portion) thereof is wider than a back surface portion (bottom surface portion) thereof. In other words, the second pad material 830 is formed so that the width decreases from the surface portion toward the back surface portion.

Therefore, the second pad material 830 can be firmly accommodated in the accommodation recess 813.

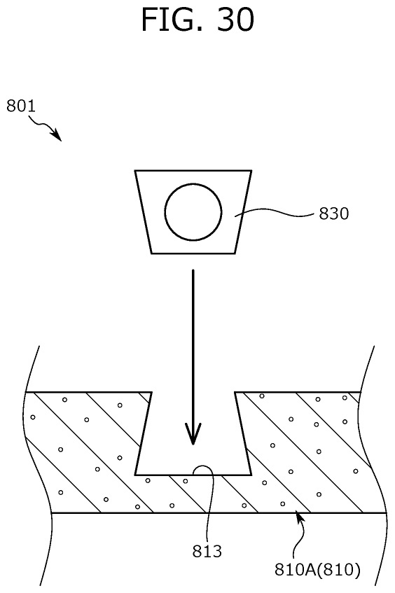

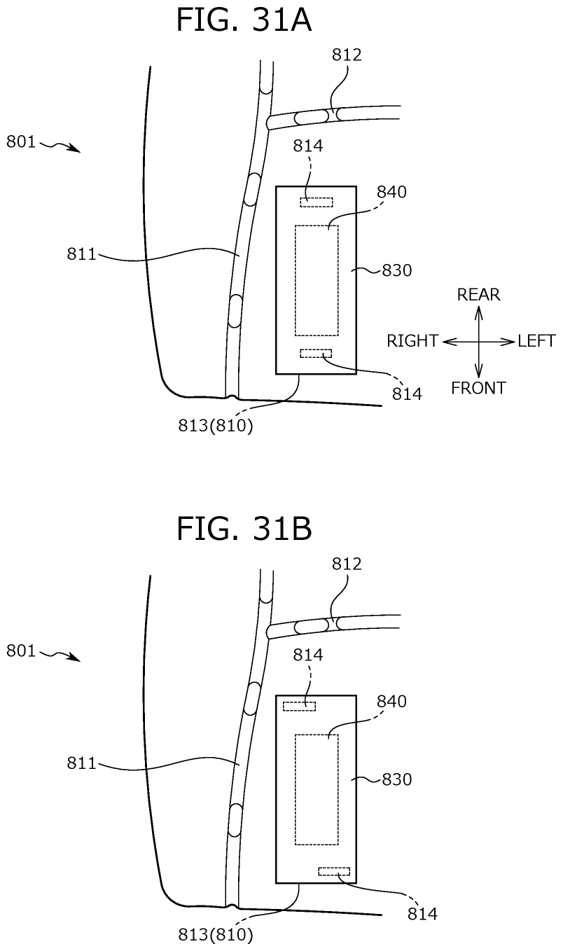

More specifically, as illustrated in FIG. 31A, the second pad material 830 is connected to the accommodation recess 813 by a connecting member 814.

The connecting member 814 is, for example, double-sided tape or a hook-and-loop fastener. Alternatively, the connecting member 814 may be an adhesive.

The connecting member 814 is interposed between the accommodation recess 813 and the second pad material 830, and is disposed at a position not overlapping with the vibration generator 840 in the thickness direction (up to down direction) of the pad material 810.

Furthermore, a plurality of connecting members 814 is provided, and is disposed at positions interposing the vibration generator 840 and at the same position in the seat width direction.

FIG. 31B is Modification Example 1 of an attachment structure of the vibration generator 840.

As illustrated in FIG. 31B, the plurality of connecting members 814 is disposed at positions interposing the vibration generator 840 and at different positions in the seat width direction.

That is, one connecting member 814 is disposed at one end of the second pad material 830 in the seat width direction, and the other connecting member 814 is disposed at the other end of the second pad material 830 in the seat width direction.

Even in the above configuration, the vibration generator 840 can be suitably attached. Further, by separating the vibration generator 840 and the connecting members 814 from each other, it is possible to suppress generation of vibration noise.

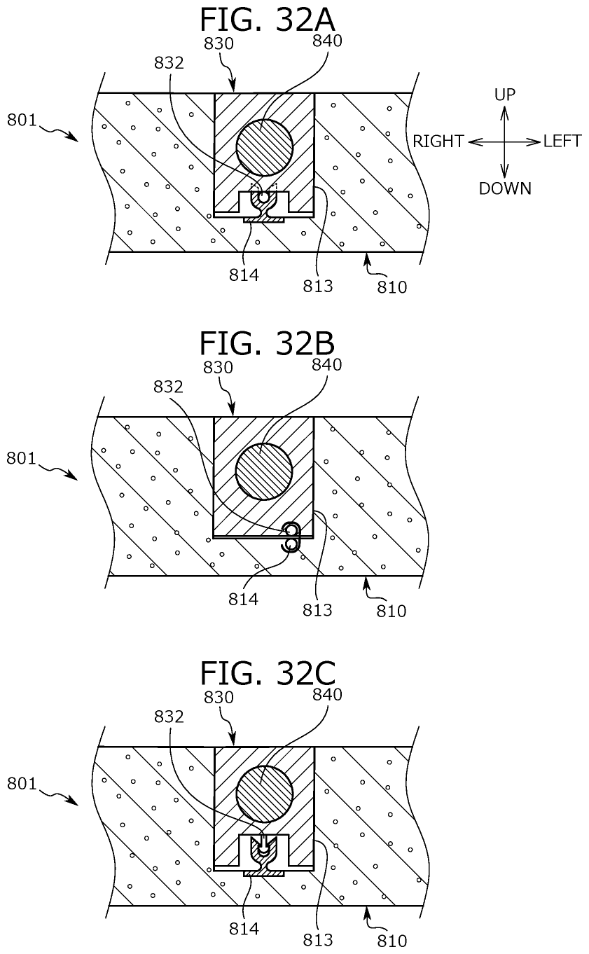

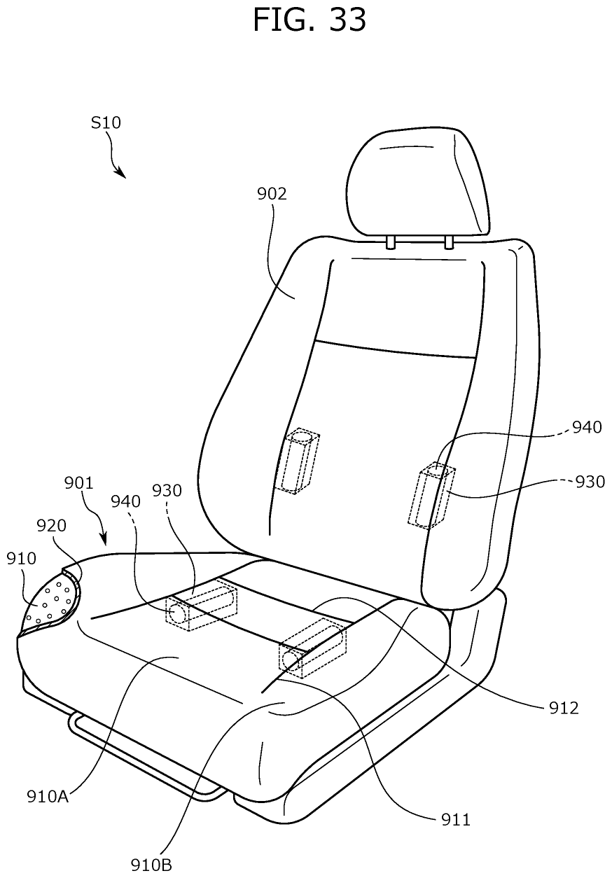

FIG. 32A is Modification Example 2 of an attachment structure of the vibration generator 840.

As illustrated in FIG. 32A, a connecting member 814 (clip) provided on a bottom surface of the accommodation recess 813 is connected to a connected member 832 (insert wire) provided at a lower end of the second pad material 830.

Even in the above configuration, the vibration generator 840 can be suitably attached.

FIG. 32B is Modification Example 3 of an attachment structure of the vibration generator 840.

As illustrated in FIG. 32B, a connecting member 814 (insert wire) provided on the bottom surface of the accommodation recess 813 and a connected member 832 (insert wire) provided at the lower end of the second pad material 830 are connected by a ring member (C-ring).

Even in the above configuration, the vibration generator 840 can be suitably attached.

FIG. 32C is Modification Example 4 of an attachment structure of the vibration generator 840.

As illustrated in FIG. 32C, a connecting member 814 (clip) provided on the bottom surface of the accommodation recess 813 is connected to a connected member 832 (trim cord) provided at the lower end of the second pad material 830.

Even in the above configuration, the vibration generator 840 can be suitably attached.

### Supplementary Note

The conveyance seat of the invention is a conveyance seat including a pad material, and includes a vibration generator provided inside the conveyance seat, and a second pad material that accommodates the vibration generator, the pad material has a pad central portion, and pad side portions located outside the pad central portion in the seat width direction, and an accommodation recess for accommodating the second pad material that accommodates the vibration generator is formed on a surface of the pad central portion.

According to the above configuration, it is possible to realize a seat that includes a vibration generator inside the seat body and can suitably apply vibration to the seated occupant while suppressing vibration noise of the vibration generator when compared to conventional ones.

To be more specific, since the vibration generator is accommodated in the second pad material, the vibration noise of the vibration generator can be suppressed more than before. Further, since the second pad material is accommodated in a surface of the pad material (pad central portion), vibration can be suitably applied to the seated occupant.

In this instance, it is preferable that an outer shape of the second pad material is larger than the accommodation recess formed in the pad material.

According to the above configuration, the second pad material can be firmly attached to the pad material, and unintentional movement of the second pad material can be suppressed.

In this instance, it is preferable that an accommodation groove for accommodating the vibration generator is formed in the second pad material, and a size of the accommodation groove is smaller than a size of the vibration generator.

According to the above configuration, it is possible to inhibit the vibration generator from moving inside the second pad material or from falling out of the second pad material.

In this instance, an opening of the accommodation recess is preferably formed to be narrower than a bottom of the accommodation recess. In other words, the accommodation recess is preferably formed to be wider from the opening toward the bottom of the accommodation recess.

According to the above configuration, it is possible to inhibit the second pad material from falling out of the accommodation recess.

In this instance, a surface portion (upper surface portion) of the second pad material is preferably formed to be wider than a back surface portion (bottom surface portion) of the second pad material. In other words, it is preferable that the second pad material is formed so that the width decreases from the surface portion toward the back surface portion of the second pad material.

According to the above configuration, it is possible to inhibit the second pad material from falling out of the accommodation recess.

In this instance, it is preferable that the second pad material is connected to the accommodation recess using double-sided tape.

Alternatively, it is preferable that the second pad material is connected to the accommodation recess using a hook-and-loop fastener.

Alternatively, it is preferable that the second pad material is connected to the accommodation recess using an adhesive.

Alternatively, it is preferable that the second pad material is connected to the accommodation recess by a connecting member, and the connecting member is a clip member, a ring member, or a trim cord.

According to the above configuration, the second pad material can be firmly attached to the pad material (accommodation recess).

In this instance, it is preferable that the second pad material is preferably connected to the accommodation recess by a connecting member, and the connecting member is disposed at a position not overlapping with the vibration generator in the thickness direction (up to down direction) of the pad material.

According to the above configuration, the second pad material can be stably attached to the pad material (accommodation recess). In addition, vibration noise of the vibration generator can be suppressed.

### Tenth Embodiment

Next, a conveyance seat S10 of a tenth embodiment will be described based on FIGS. 33 to 36B.

Note that description of content that overlaps with the above-mentioned conveyance seats S1 to S9 will be omitted.

The conveyance seat S10 includes a vibration generator inside the seat body, and realizes a seat capable of suitably applying vibration to the seated occupant while suppressing vibration noise of the vibration generator when compared to conventional ones.

As illustrated in FIG. 33, the conveyance seat S10 includes a seat cushion 901, a seat back 902, and a vibration generator 940 attached inside each of the seat cushion 901 and the seat back 902.

The seat cushion 901 includes a pad material 910 (first pad material) and a skin material 920 that covers the pad material 910.

Note that the seat back 902 also has a similar configuration.

The pad material 910 includes a pad central portion 910A and right and left pad side portions 910B.

Right and left first skin pull-in grooves 911 and second skin pull-in grooves 912 connecting the right and left first skin pull-in grooves 911 are formed on a surface of the pad material 910. Note that skin attachment members 911a and 912a for attaching skin terminals of the skin material 920 are provided inside the skin pull-in grooves 911 and 912.

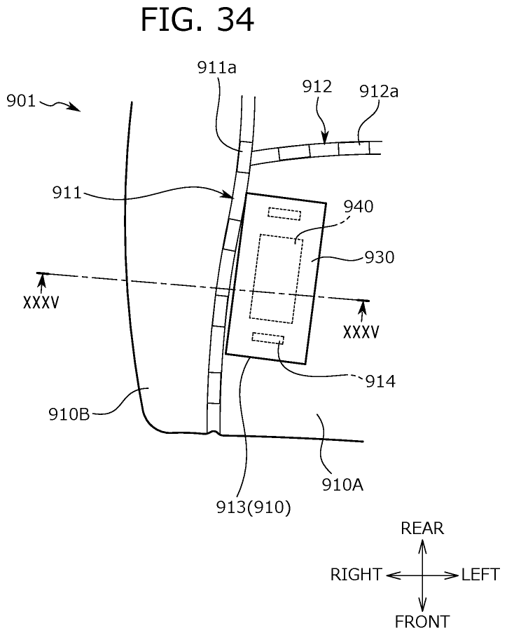

Further, as illustrated in FIG. 34, an accommodation recess 913 for accommodating a second pad material 930 is formed in each of right and left side portions of the pad central portion 910A.

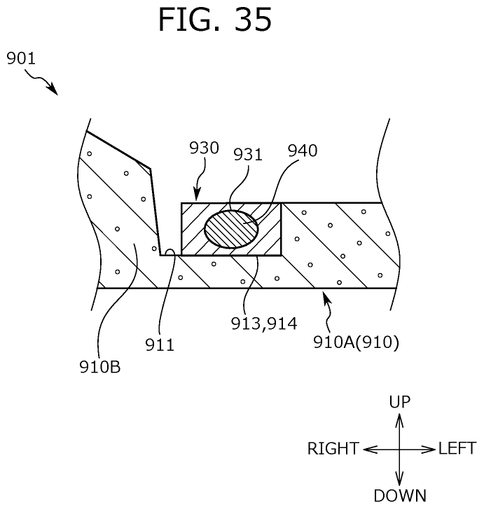

As illustrated in FIGS. 34 and 35, the second pad material 930 is a rectangular parallelepiped-shaped pad material, and is accommodated in the recess-shaped accommodation recess 913.

An accommodation groove 931 for accommodating a vibration generator 940 is formed on a surface (for example, a front surface) of the second pad material 930.

The second pad material 930 is connected to the accommodation recess 913 by a connecting member 914.

In the above configuration, as illustrated in FIGS. 34 and 35, the skin pull-in grooves (first skin pull-in grooves 911) and the accommodation recesses 913 are continuously formed. In other words, the first skin pull-in grooves 911 and the accommodation recesses 913 are connected.

That is, as illustrated in FIG. 35, by accommodating the second pad material 930 in the accommodation recess 913, the skin pull-in groove 911 is formed between the second pad material 930 and the pad side portion 910B.

In this way, a size of the seat cushion 901 in the seat width direction can be reduced.

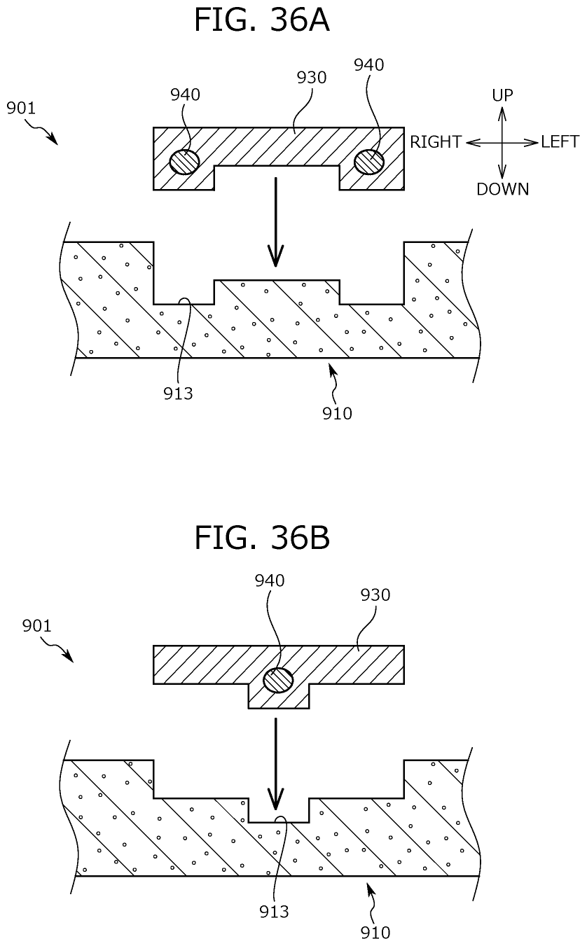

FIGS. 36A and 36B are Modification Example 5 and Modification Example 6 of an attachment structure of the vibration generator 940.

In FIG. 36A, the second pad material 930 has a reverse recess shape and is accommodated to fit into the accommodation recess 913 having a reverse recess shape. Further, the vibration generator 940 is disposed in each of right and left side portions of the second pad material 930.

In FIG. 36B, the second pad material 930 has a reverse convex shape and is accommodated to fit into the accommodation recess 913 having a reverse convex shape. The vibration generator 940 is disposed at a central position of the second pad material 930.

In this way, the second pad material 930 may have any shape such as an elliptical shape, a triangular shape, or an inverted triangular shape in addition to the rectangular parallelepiped shape. In other words, it is sufficient that the accommodation recess 913 has a shape and size corresponding to the second pad material 930.

In addition, the accommodation groove 931 of the second pad material 930 is a bottomed hole, but may be changed to a penetrating hole to facilitate molding of the second pad material 930.

For example, a pad material longer than the accommodation recess 913 of the pad material 910 is first molded, and a plurality of second pad materials 930 is formed by cutting the pad material. In this instance, when the accommodation groove 931 of the second pad material 930 is a through-hole, the second pad material 930 is easily molded. Furthermore, by separately forming a through-hole in the second pad material 930, a harness extending from the vibration generator 940 can be passed through the through-hole.

### Eleventh Embodiment

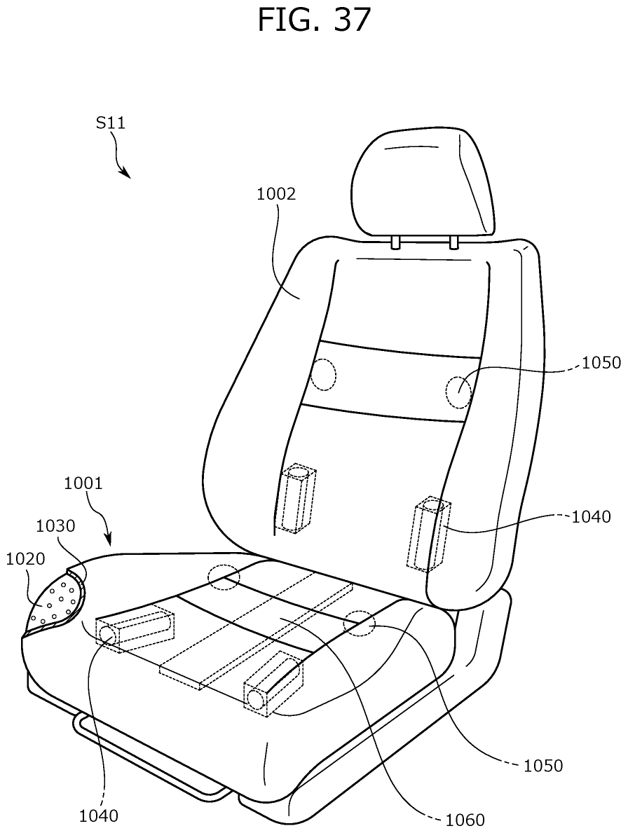

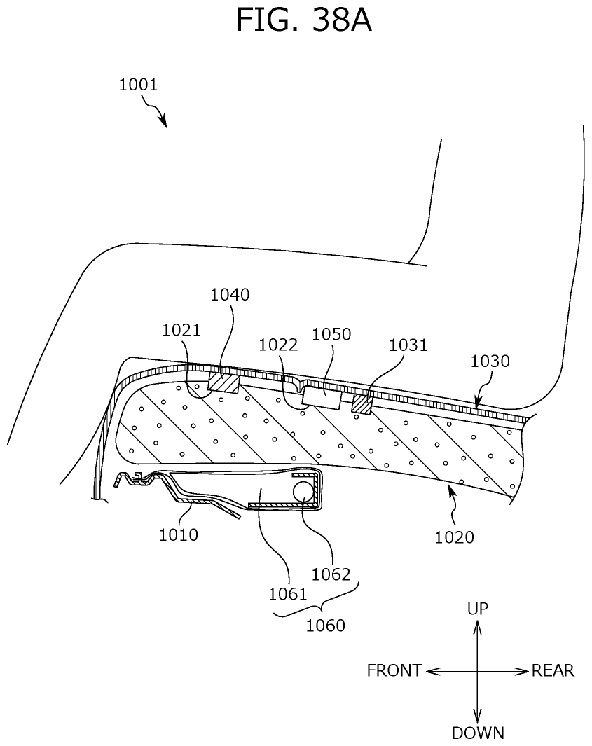

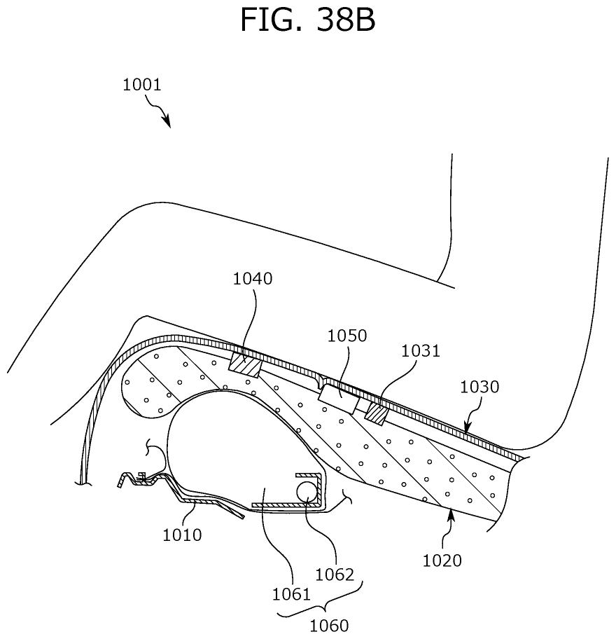

Next, a conveyance seat S11 of an eleventh embodiment will be described based on FIGS. 37 to 38B.

Note that description of content that overlaps with the above-mentioned conveyance seats S1 to S10 will be omitted.

The conveyance seat S11 includes a vibration generator and an airbag device inside a seat body, and realizes a seat having devised arrangement layout so that the vibration generator and the airbag device properly function.

As illustrated in FIG. 37, the conveyance seat S10 includes a seat cushion 1001, a seat back 1002, and a vibration generator 1040 attached inside each of the seat cushion 1001 and the seat back 1002.

Furthermore, the conveyance seat S10 includes an air cell 1050 attached inside each of the seat cushion 1001 and the seat back 1002, and an airbag device 1060 attached inside the seat cushion 1001.

As illustrated in FIGS. 37 and 38A, the seat cushion 1001 includes a cushion frame 1010, a pad material 1020 placed on the cushion frame 1010, and a skin material 1030 covering the cushion frame 1010 and the pad material 1020.

An accommodation recess 1021 for accommodating the vibration generator 1040 and a second accommodation recess 1022 for accommodating the air cell 1050 are formed on a surface of the pad material 1020.

Skin pull-in clips 1031 are attached to skin terminals of the skin material 1030 with a predetermined interval.

Note that the seat back 902 also has a similar configuration.

The vibration generator 1040 is a vibration motor that applies vibration to the seated occupant, and is disposed at each of right and left side positions of a front portion of the seat cushion 1001.

Each vibration generator 1040 is stored in an accommodation recesses 1023.

The air cell 1050 is a bag body that bulges to move the seat cushion 1001 from a “normal position” to a “protruding position” protruding from the normal position toward the seated occupant side.

Air cells 1050 are disposed at right and left side positions of a rear portion of the seat cushion 1001, and are each accommodated in a second accommodation recess 1024.

Note that the air cell 1050 is connected to a fluid supply device that supplies compressed air to the air cell 1050.

By using the air cell 1050, a position of the seat cushion 1001 in the up to down direction can be adjusted, and buttocks of the seated occupant can be massaged.

As illustrated in FIGS. 37 to 38B, the airbag device 1060 is a device in which a folded airbag 1061 bulges and deploys upward when an external impact is applied. The airbag device 1060 is also referred to as a cushion airbag device.

The airbag device 1060 is disposed at a central position of the seat cushion 1001 in the seat width direction, and is attached to an upper surface of the cushion frame 1010.

The airbag device 1060 includes an airbag 1061 that bulges and deploys upward (toward the pad material 1020 side), an inflator 1062 that supplies gas into the airbag 1061, and a harness (not illustrated) connected to the inflator 1062 to supply ignition power to the inflator 1062.

Note that the harness is connected to a vehicle battery (not illustrated).

By using the airbag device 1060, it is possible to inhibit the seated occupant from slipping under a seatbelt and being thrown forward of the seat in the event of a vehicle collision. The so-called submarine phenomenon of the seated occupant can be suppressed.

Specifically, as illustrated in FIG. 38B, the seat cushion 1001 is lifted upward when the airbag device 1060 operates in the event of a vehicle collision. Therefore, it is possible to prevent the seated occupant from slipping under the seat belt and being thrown forward of the seat.

In the above configuration, as illustrated in FIG. 37, the vibration generator 1040, the air cell 1050, and the airbag device 1060 are disposed at different positions (non-overlapping positions) in the seat cushion 1001. In other words, these devices 1040, 1050, and 1060 are disposed at different positions in the seat front to rear direction or the seat width direction, respectively.

Therefore, a thickness of the pad material 1020 can be ensured, and the seating feeling of the conveyance seat S10 can be improved. Moreover, it becomes easier to manufacture the conveyance seat S10.

Note that, as a modification example, the vibration generator 1040, the air cell 1050, and the airbag device 1060 may be disposed at overlapping positions in the seat cushion 1001.

In that case, arrangement layout of these devices 1040, 1050, and 1060 can be made free. In other words, it becomes easier to design the conveyance seat S10.

### Twelfth Embodiment

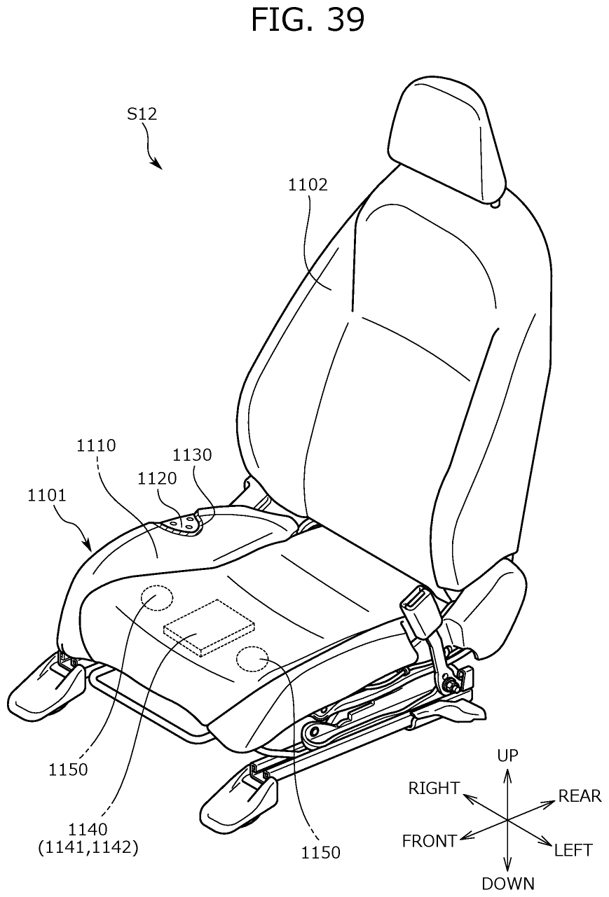

Next, a conveyance seat S12 of a twelfth embodiment will be described based on FIGS. 39 to 42B.

Note that description of content that overlaps with the above-mentioned conveyance seats S1 to S11 will be omitted.

The conveyance seat S12 includes an air blower and a vibration generator inside a seat body, and realizes a seat capable of smoothly operating both the air blower and the vibration generator by devising arrangement layout thereof.

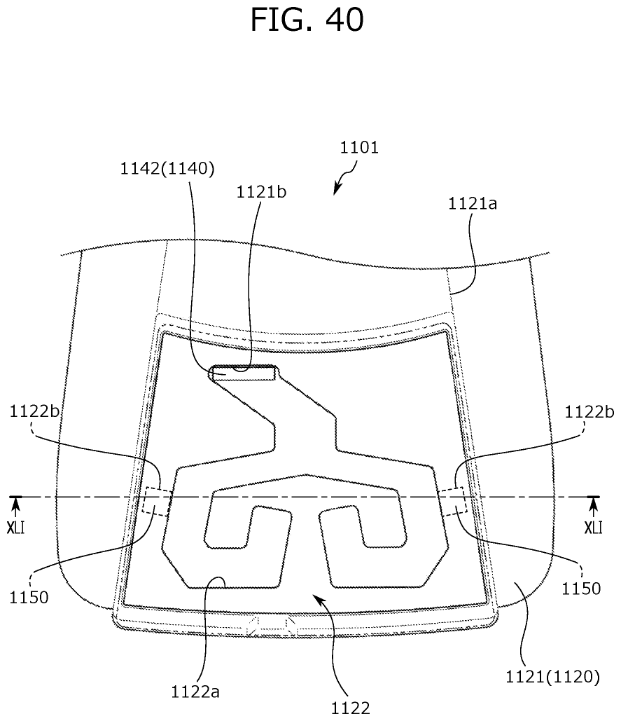

As illustrated in FIGS. 39 and 40, the conveyance seat S12 includes a seat cushion 1101, a seat back 1102, an air blower 1140 that is attached inside the seat cushion 1101 and blows air toward the seated occupant, and a vibration generator 1150 that applies vibration to the seated occupant.

The seat cushion 1101 includes a cushion frame 1110, a pad material 1120, and a skin material 1130.

As illustrated in FIG. 40, the pad material 1120 is a pad stacked body and includes a first pad material 1121 and a second pad material 1122 softer than the first pad material 221.

The second pad material 1122 is attached to a surface of a central portion of the first pad material 1121 in the seat width direction, and covers the central portion of the first pad material 1121 from above.

A skin pull-in groove 1121a for pulling in a skin terminal of the skin material 1130 and a duct insertion hole 1121b for inserting a duct 1142 of the air blower 1140 are formed on a surface of the first pad material 1121.

A ventilation passage 1122a for guiding air blown out from a blowout portion of the duct 1142 is formed on a surface of the second pad material 1122.

In addition, an accommodation groove 1122b for accommodating the vibration generator 1150 is formed on the surface of the second pad material 1122 at a position adjacent to the ventilation passage 1122a.

The accommodation groove 1122b is formed outside the ventilation passage 1122a in the seat width direction, and is connected to the ventilation passage 1122a.

The air blower 1140 includes a blower 1141 that is attached to the cushion frame 1110 and blows out air, and a duct 1142 that is connected to the blower 1141 and allows air to pass through.

The blowout portion of the duct 1142 is an outlet that blows out air toward the seated occupant, and is exposed on a surface of the pad material 1120.

The vibration generator 1150 is a vibration motor, and is accommodated in the accommodation groove 1122b (accommodation space) formed in the pad material 1120 (second pad material 1122) of the seat cushion 1101.

For example, the vibration generator 1150 is accommodated in the accommodation groove 1122b by being pushed from the ventilation passage 1122a toward the accommodation groove 1122b.

The vibration generator 1150 is connected to a control device (not illustrated) by a harness 1160. The harness 1160 passes through insertion holes 1121c and 1122c formed in the first pad material 1121 and the second pad material 1122 and extends below the pad material 1120.

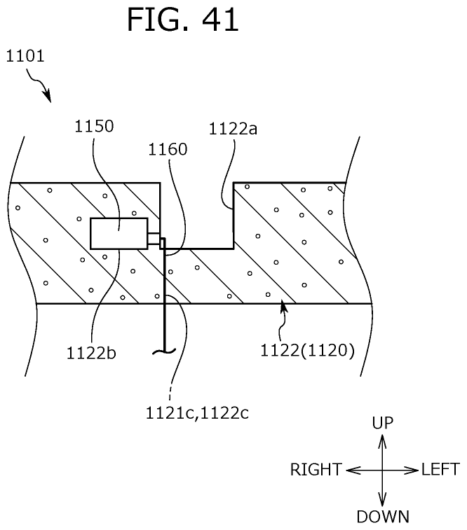

In the above configuration, as illustrated in FIG. 41, the vibration generator 1150 is accommodated in the accommodation groove 1122b of the pad material 1120, and is completely surrounded by the pad material 1120.

Therefore, vibration noise generated from the vibration generator 1150 can be suppressed.

Further, in the above configuration, as illustrated in FIG. 41, the accommodation groove 1122b is formed adjacent to the ventilation passage 1122a. In other words, the accommodation groove 1122b is a groove formed on an inner surface of the ventilation passage 1122a.

Therefore, the accommodation groove 1122b can be easily formed using the ventilation passage 1122a. Furthermore, by forming the accommodation groove 1122b adjacent to the ventilation passage 1122a, the seat cushion 1101 (pad material 1120) can be made smaller.

Note that, even though the accommodation groove 1122b is formed on the inner surface of the ventilation passage 1122a, the invention is not particularly limited, and the accommodation groove 1122b may be formed on an inner surface of the skin pull-in groove 1121a.

Further, in the above configuration, as illustrated in FIG. 41, an opening of the accommodation groove 1122b is formed to be narrower than an accommodation portion of the accommodation groove 1122b.

Therefore, the vibration generator 1150 can be firmly accommodated in the accommodation groove 1122b. That is, the vibration generator 1150 is favorably held inside the pad material 1120.

Further, in the above configuration, as illustrated in FIG. 41, the harness 1160 extends below the pad material 1120 through the insertion holes 1121c and 1122c formed in a bottom surface of the ventilation passage 1122a.

Therefore, exposure of the harness 1160 to the surface of the pad material 1120 can be avoided. In other words, the harness can be suitably protected with a simple structure.

Note that the vibration generator 1150 is accommodated in the accommodation groove 1122b by being pushed toward the accommodation groove 1122b.

Meanwhile, the vibration generator 1150 may be accommodated inside the pad material 1120 (accommodation groove 1122b) by being integrally foam-molded with the pad material 1120.

In that case, an operation of attaching the vibration generator 1150 becomes easier.

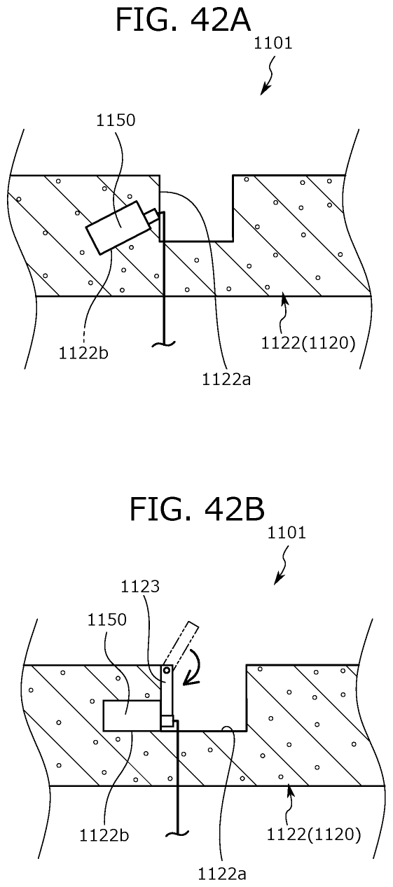

FIG. 42A is Modification Example 1 of an arrangement pattern of the vibration generator 1150.

According to FIG. 42A, the accommodation groove 1122b is formed on the inner surface of the ventilation passage 1122a, and extends downward while being inclined with respect to the thickness direction of the pad material 1120. In other words, the accommodation groove 1122b is formed to be inclined with respect to the ventilation passage 1122a.

In this way, the vibration generator 1150 can be easily accommodated in the accommodation groove 1122b.

FIG. 42B is Modification Example 2 of the arrangement pattern of the vibration generator 1150.

According to FIG. 42B, the accommodation groove 1122b is formed on the inner surface of the ventilation passage 1122a. A movable body 1123 (rotating body) for opening and closing the accommodation groove 1122b is attached to the inner surface of the ventilation passage 1122a.

The movable body 1123 is movable between an “open position” in which the accommodation groove 1122b is opened and a “closed position” in which the accommodation groove 1122b is closed.

In this way, after the vibration generator 1150 is accommodated in the accommodation groove 1122b, the movable body 1123 can close the opening of the accommodation groove 1122b. In other words, the vibration generator 1150 can be easily accommodated in the accommodation groove 1122b.

Further, according to FIG. 42B, the accommodation groove 1122b is formed on the bottom side of the ventilation passage 1122a with respect to an opening of the ventilation passage 1122a on the inner surface of the ventilation passage 1122a.

Specifically, the accommodation groove 1122b is formed at a position facing the bottom of the ventilation passage 1122a.

In this way, the vibration generator 1150 accommodated in the accommodation groove 1122b is suitably held. In other words, it is possible to inhibit the vibration generator 1150 from falling out of the pad material 1120.

### Thirteenth Embodiment

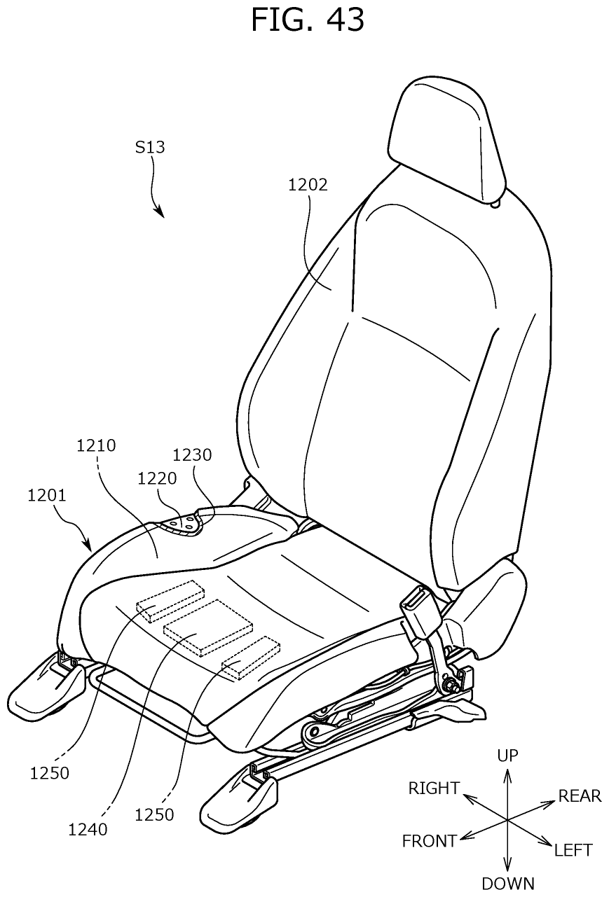

Next, a conveyance seat S13 of a thirteenth embodiment will be described based on FIGS. 43 to 45.

Note that description of content that overlaps with the above-mentioned conveyance seats S1 to S12 will be omitted.

The conveyance seat S13 includes an air conditioner and a vibration generator inside a seat body, and realizes a seat capable of smoothly operating both the air conditioner and the vibration generator by devising arrangement layout thereof.

As illustrated in FIG. 43, the conveyance seat S13 includes a seat cushion 1201, a seat back 1202, an air conditioner 1240 attached inside the seat cushion 1201 to adjust temperature and humidity of air inside the seat cushion 1201, and a vibration generator 1250 attached inside the seat cushion 1201 to apply vibration to the seated occupant.

The seat cushion 1201 includes a cushion frame 1210, a pad material 1220, and a skin material 1230.

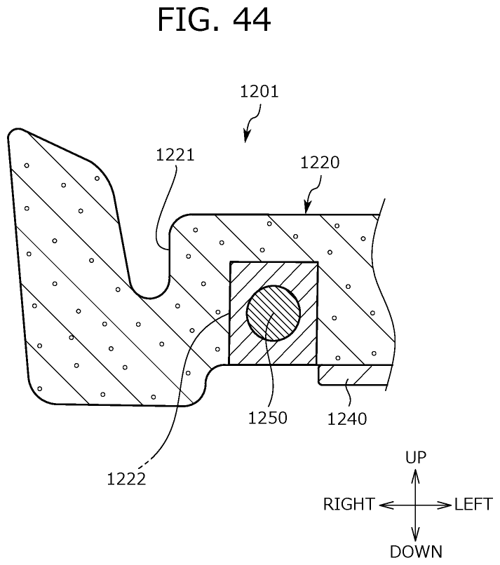

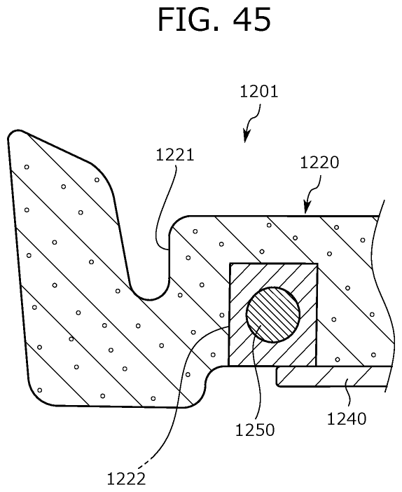

As illustrated in FIG. 44, a skin pull-in groove 1221 for pulling in a skin terminal of the skin material 1230 is formed on a surface of the pad material 1220.

An accommodation groove 1222 that accommodates the vibration generator 1250 is formed on a back surface of the pad material 1220.

The air conditioner 1240 is attached to the back surface of the pad material 1220.

The air conditioner 1240 is, for example, a thermal control insert, and is a device that performs an air conditioning function of the seat cushion 1201 by sending air from the back surface of the pad material 1220 to the surface of the pad material 1220.

The air conditioner 1240 is disposed at a central portion of the pad material 1220 in the seat width direction.

The vibration generator 1250 is a vibration motor and is accommodated in the accommodation groove 1222 (accommodation space) of the pad material 1220.

The vibration generator 1250 is disposed at each of right and left side positions of the pad material 1220 in the seat width direction.

In the above configuration, as illustrated in FIG. 44, the air conditioner 1240 and the vibration generator 1250 are disposed at different positions (non-overlapping positions) in the seat width direction of the seat cushion 1201.

In this way, the conveyance seat S13 can smoothly operate these devices 1240 and 1250 inside the seat cushion 1201.

Note that, as in the modification example illustrated in FIG. 45, the air conditioner 1240 and the vibration generator 1250 may be disposed at overlapping positions.

In that case, arrangement layout of these devices 1240 and 1250 can be made free. In other words, it becomes easier to design the conveyance seat S10.

### Fourteenth Embodiment

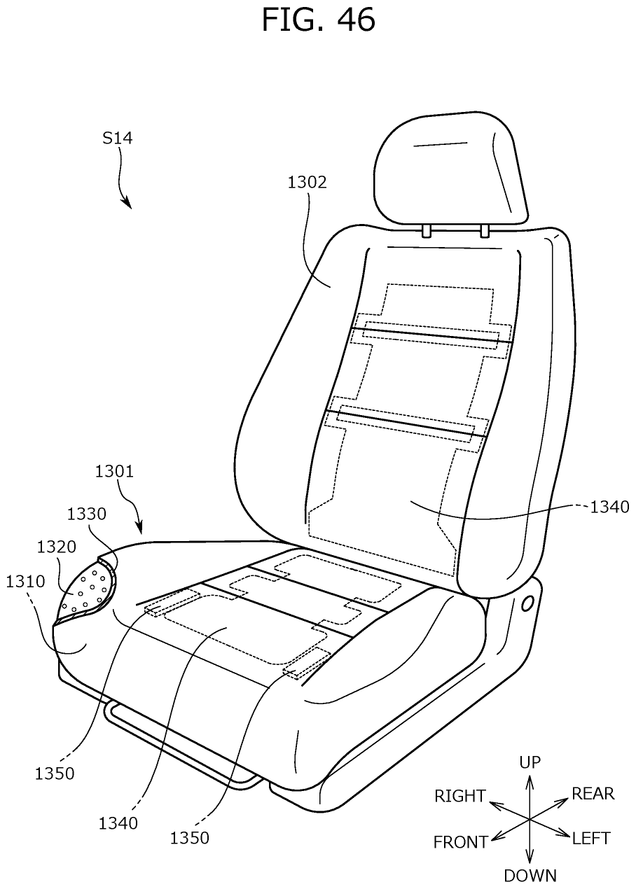

Next, a conveyance seat S14 of a fourteenth embodiment will be described based on FIGS. 46 to 48.

Note that description of content that overlaps with the above-mentioned conveyance seats S1 to S13 will be omitted.

The conveyance seat S14 includes a seat heater and a vibration generator inside a seat body, and realizes a seat capable of smoothly operating both the seat heater and the vibration generator by devising arrangement layout thereof.

As illustrated in FIG. 46, the conveyance seat S14 includes a seat cushion 1301, a seat back 1302, a seat heater 1340 attached inside the seat cushion 1301, and a vibration generator 1350 attached inside the seat cushion 1301.

The seat cushion 1301 includes a cushion frame 1310, a pad material 1320, and a skin material 1330.

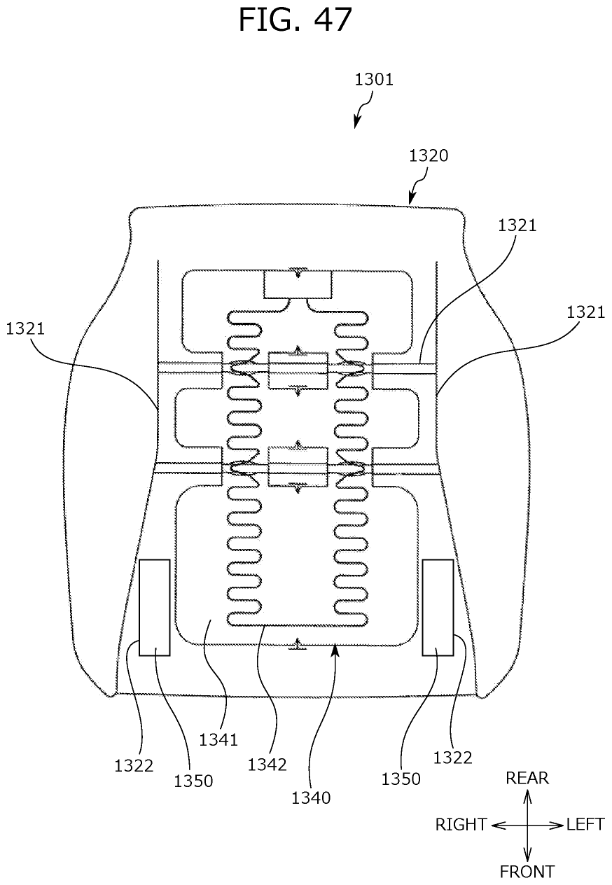

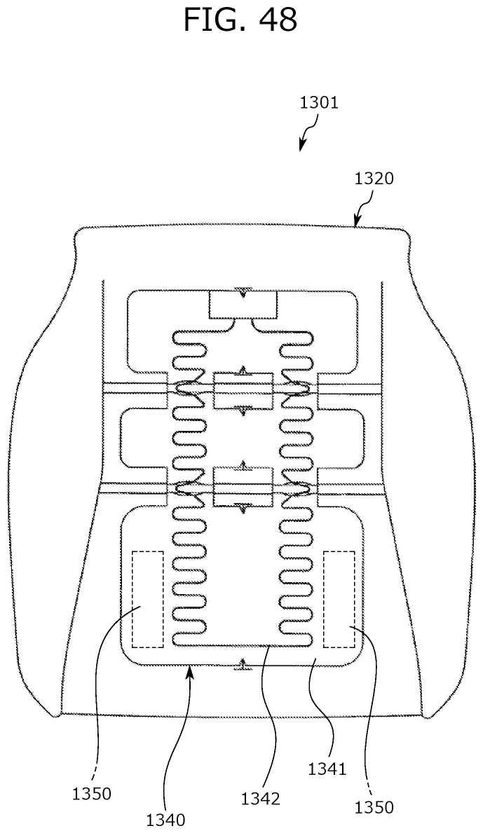

As illustrated in FIG. 47, a skin pull-in groove 1321 for pulling in a skin terminal of the skin material 1330 and an accommodation groove 1322 for accommodating the vibration generator 1350 are formed on a surface of the pad material 1320.

The seat heater 1340 is attached to the surface of the pad material 1320.

The seat heater 1340 is a planar heating element and is disposed between the pad material 1320 and the skin material 1330.

The seat heater 1340 is disposed at a central position of the pad material 1320 in the seat width direction.

The seat heater 1340 includes a sheet-shaped seat base material 1341 and a heater wire 1342 attached onto the seat base material 1341.

The vibration generator 1350 is a vibration motor and is accommodated in the accommodation groove 1322 (accommodation space) of the pad material 1320. The vibration generator 1350 is disposed at each of right and left side positions of the pad material 1320 in the seat width direction.

In the above configuration, as illustrated in FIG. 47, the seat heater 1340 and the vibration generator 1350 are disposed at different positions (non-overlapping positions) in the seat cushion 1301.

Specifically, the right and left vibration generators 1350 are disposed outside the seat heater 1340 in the seat width direction.

In this way, the conveyance seat S14 can smoothly operate these devices 1340 and 1350 inside the seat cushion 1301.

Note that, as in the modification example illustrated in FIG. 48, the seat heater 1340 and the vibration generator 1350 may be disposed at overlapping positions.

Specifically, the seat base material 1341 of the seat heater 1340 and the vibration generator 1350 may overlap each other.

In that case, arrangement layout of these devices 1340 and 1350 can be made free. Further, the heater wire 1342 of the seat heater 1340 and the vibration generator 1350 do not overlap each other, and thus can operate without being influenced by each other.

### Fifteenth Embodiment

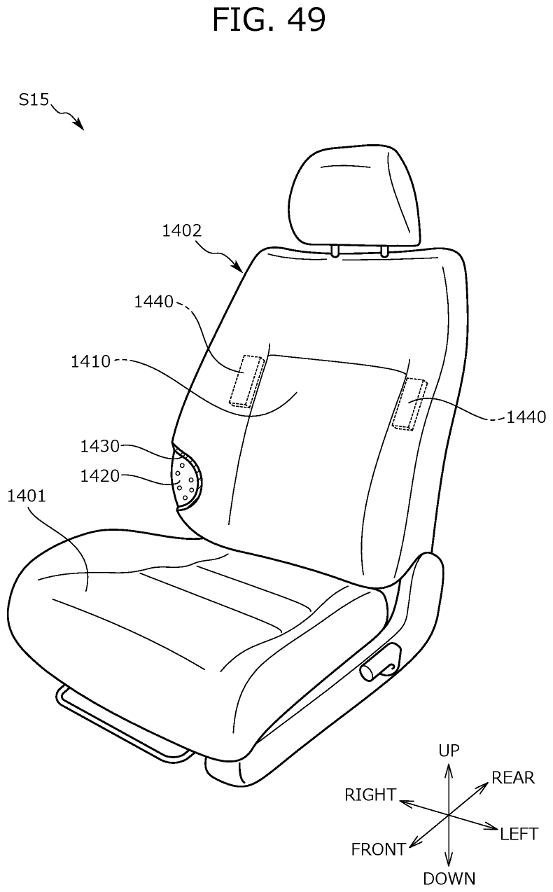

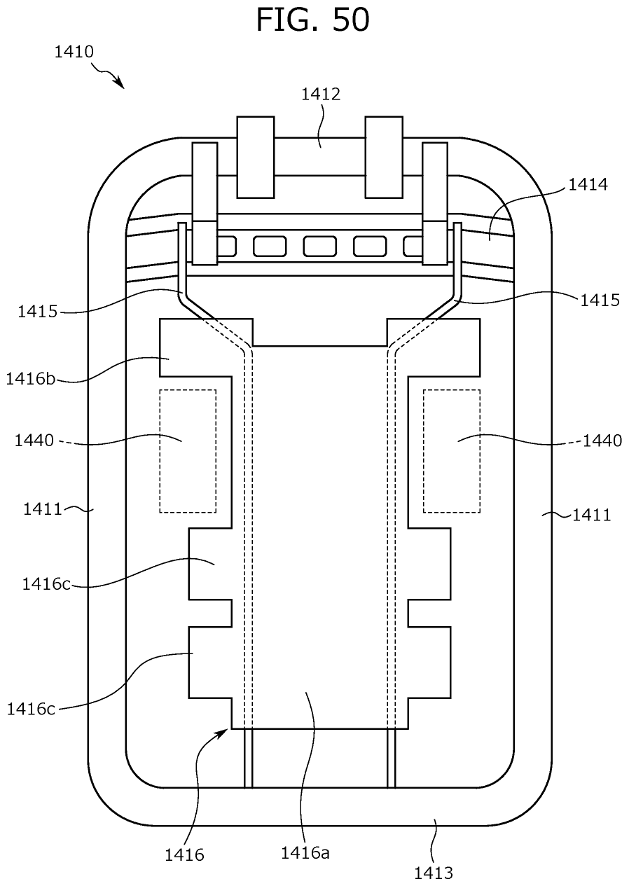

Next, a conveyance seat S15 of a fifteenth embodiment will be described based on FIGS. 49 to 50.

Note that description of content that overlaps with the above-mentioned conveyance seats S1 to S14 will be omitted.

As illustrated in FIG. 49, the conveyance seat S15 includes a seat cushion 1401, a seat back 1402, and a vibration generator 1440 attached inside the seat back 1402.

The seat back 1402 includes a back frame 1410, a pad material 1420 (urethane pad), and a skin material 1430.

The back frame 1410 includes right and left side frames 1411, an upper frame 1412, a lower frame 1413, a connecting frame 1414 that connects the right and left side frames 1411, right and left wire members 1415 that extend in the up to down direction and are hooked to the connecting frame 1414 and the lower frame 1413, and a support plate 1416 held by the wire members 1415 to support the seated occupant.

The support plate 1416 includes a rectangular plate main body portion 1416a, plate protrusions 1416b provided at right and left upper end portions of the plate main body portion 1416a, and second plate protrusions 1416c provided at right and left side end portions of the plate main body portion 1416a.

The plate protrusions 1416b protrude further outward in the seat width direction than the second plate protrusions 1416c.

The vibration generator 1440 is a vibration motor and is disposed at each of right and left side portions of the seat back 1402.

Specifically, the right and left vibration generators 1440 are accommodated in right and left accommodation recesses 1321 formed on a surface of the pad material 1420, respectively.

In the above configuration, as illustrated in FIG. 50, the right and left vibration generators 1440 are disposed at different positions from the back frame 1410 (particularly the support plate 1416) when viewed from the front. In other words, the right and left vibration generators 1440 are disposed at positions not overlapping the support plate 1416 in the seat front to rear direction.

Specifically, the right and left vibration generators 1440 are disposed outside the plate main body portion 1416a in the seat width direction, and are disposed between the plate protrusions 1416b and the second plate protrusions 1416c in the up to down direction.

In this way, even when a seating load from the seated occupant is applied to the seat back 1402, it is possible to inhibit the vibration generators 1440 from interfering with the support plate 1416. As a result, damage to the vibration generators 1440 can be suppressed.

### Others

Even though the conveyance seats S1 to S15 are assumed to be employed as front seats of a vehicle, the conveyance seats may also be employed as rear seats of a vehicle.

In this way, the conveyance seats each become a conveyance seat capable of applying vibration to an occupant other than a driver. It is preferable that different types of vibration generators are attached to the conveyance seat. Then, it is preferable to operate a predetermined vibration generator in conjunction with music playing inside the vehicle.

In the above embodiment, a vehicle seat used in an automobile has been described as a specific example. However, the invention is not particularly limited. The vehicle seat may be used for various seats such as office chairs for work, wheelchairs, and children's chairs of shopping carts in addition to motorcycle seats for motorcycles, vehicle seats of trains, buses, etc., and conveyance seats of airplanes, ships, etc.

In the embodiments, the conveyance seats according to the invention have been mainly described.

However, the above embodiments are only an example to facilitate understanding of the invention, and do not limit the invention. It is obvious that the invention can be modified and improved without departing from the spirit and includes equivalents thereto.

### REFERENCE SIGNS LIST

### First Embodiment

S1: conveyance seat
1: seat cushion
1A: central portion
1B: side portion
2: seat back
2A: central portion
2B: side portion
   2a, 3a: pad material
   2b, 3a: skin material
3: headrest
4: reclining device
5: height link device
6: rail device
10: pad material
10A: central pad portion
10B: side pad portion
   10AA: first central pad portion (first pad portion)
   10AB: second central pad portion (second pad portion)
   10AC: third central pad portion (third pad portion)
10B: side pad portion
11: first pull-in groove (pull-in groove)
12: second pull-in groove (pull-in groove)
13: insert wire
14: C-ring
20: skin material
20a: skin end portion
21: slab material (wadding material)
22: pull-in member
30, 40: seat heater
   30a: first heater portion
   30b: second heater portion
   30c: third heater portion
   30d: first heater connecting portion (heater connecting portion)
   30e: second heater connecting portion
31: seat base material
32: electric wire
   32a: harness
33: heater wire
   33a: heater wire portion
34: temperature measurement sensor
35: temperature adjustment device

### Second Embodiment

S2: conveyance seat
101: seat cushion
102: seat back
110: pad material
110A: central pad portion
110B: side pad portion
111: first pull-in groove (pull-in groove)
120: skin material
120a: skin end portion
130, 140: seat heater
   130a: central heater portion
   130b, 130c: side heater portion
   130d, 130e: heater connecting portion

### Third Embodiment

S3: conveyance seat
201: seat cushion
   201a: skin material
202: seat back
   202a: skin material
210: cushion frame
220: pad material
221: first pad material
   221a: first skin pull-in groove
   221b: second skin pull-in groove
   221c: duct insertion hole
222: second pad material
   222a: ventilation passage
223: third pad material
   223a: ventilation hole
230: back frame
240: pad material
241: first pad material
   241a: duct insertion hole
   241b: ventilation passage
242: second pad material
   242b: ventilation hole
250: air blower
251: attachment bracket
252: blower
253: duct
254: blowout portion (seat cushion side)
255: second blowout portion (seat back side)
260: vibration generator
270: seat heater
   270a: first heater portion
   27b: second heater portion
   270c: third heater portion
   270d: first heater connecting portion
   270e: second heater connecting portion
271: seat base material
272: heater wire

### Fourth Embodiment

S4: conveyance seat
301: seat cushion
302: seat back
303: headrest
310: seating sensor
320: vehicle speed sensor
330: vibration generator
340: control device
350: weight sensor
360: sitting height detection sensor
V: vehicle

### Fifth Embodiment

S5: conveyance seat
401: seat cushion
   401a: pad material
   401b: skin material
402: seat back
403: headrest
410: vibration generator
411: main body portion
412: first transmission portion
413: second transmission portion

### Sixth Embodiment

S6: conveyance seat
501: seat cushion
502: seat back
   502a: pad material
   502b: skin material
510: back frame
511: back side frame
512: upper frame
513: lower frame
514: wire member
515: support plate
520: lumbar support (movable body)
530: driving device
531: driving main body portion
532: first cable
533: second cable
534: third cable
540: vibration generator (movable body)
541: main body portion
542: first case
543: second case
544: attachment bracket

### Seventh Embodiment

S7: conveyance seat
601: seat cushion
602: seat back
610: first vibration generator
620: second vibration generator
630: control device

### Eighth Embodiment

S8: conveyance seat
701: seat cushion
   701a: pad material
      701aa: skin pull-in groove
      701ab: through-hole
   701b: skin material
702: seat back
710: vibration generator
720: control device
730: harness
740: protection member
750: harness accommodation groove
760: second protection member

### Ninth Embodiment

S9: conveyance seat
801: seat cushion
802: seat back
810: pad material (first pad material)
   810A: pad central portion
   810B: pad side portion
811: first skin pull-in groove
812: second skin pull-in groove
813: accommodation recess
814: connecting member (double-sided tape, hook-and-loop fastener, adhesive, clip, insert wire)
820: skin material
830: second pad material
831: accommodation groove
832: connected member (insert wire, trim cord)
840: vibration generator

### Tenth Embodiment

S10: conveyance seat
901: seat cushion
902: seat back
910: pad material (first pad material)
   910A: pad central portion
   910B: pad side portion
911: first skin pull-in groove (skin pull-in groove)
912: second skin pull-in groove
   911a, 912a: skin attachment member
913: accommodation recess
914: connecting member
920: skin material
930: second pad material
931: accommodation groove
940: vibration generator

### Eleventh Embodiment

S11: conveyance seat
1001: seat cushion
1002: seat back
1010: cushion frame
1020: pad material
1021: accommodation recess
1022: second accommodation recess
1030: skin material
1031: skin pull-in clip (skin pull-in member)
1040: vibration generator
1050: air cell
1060: airbag device
1061: airbag (cushion airbag)
1062: inflator

### Twelfth Embodiment

S12: conveyance seat
1101: seat cushion
1102: seat back
1110: cushion frame
1120: pad material
1121: first pad material
   1121a: skin pull-in groove
   1121b: duct insertion hole
   1121c:insertion hole
1122: second pad material
   1122a: ventilation passage
   1122b: accommodation groove
   1122c: insertion hole
1123: movable body
1130: skin material
1140: air blower
1141: blower
1142: duct
1150: vibration generator
1160: harness

### Thirteenth Embodiment

S13: conveyance seat
1201: seat cushion
1202: seat back
1210: cushion frame
1220: pad material
1221: skin pull-in groove
1222: accommodation groove
1230: skin material
1240: air conditioner
1250: vibration generator

### Fourteenth Embodiment

S14: conveyance seat
1301: seat cushion
1302: seat back
1310: cushion frame
1320: pad material
1321: skin pull-in groove
1322: accommodation groove
1330: skin material
1340: seat heater
1341: seat base material
1342: heater wire
1350: vibration generator

### Fifteenth Embodiment

S15: conveyance seat
1401: seat cushion
1402: seat back
1410: back frame
1411: side frame
1412: upper frame
1413: lower frame
1414: connecting frame
1415: wire member
1416: support plate
   1416a: plate main body portion
   1416b: plate protrusion
   1416c: second plate protrusion
1420: pad material
1430: skin material
1440: vibration generator

1. A conveyance seat comprising:
a seat body including a pad material and a skin material covering the pad material; and
a sheet-shaped seat heater disposed between the pad material and the skin material inside the seat body and attached to a back surface on a side of the skin material, wherein:
the pad material has pull-in grooves each formed on a surface of the pad material and used to pull in a skin end portion of the skin material,
the pull-in grooves extend along a predetermined direction on the surface of the pad material and are provided to partition the pad material into a first pad portion and a second pad portion,
the seat heater has:
a first heater portion disposed on a surface of the first pad portion;
a second heater portion disposed on a surface of the second pad portion; and
heater connecting portions that are disposed to straddle the pull-in grooves, connect the first heater portion and the second heater portion, and are formed to be narrower than the first heater portion and the second heater portion, and
the heater connecting portions are attached to the skin end portion of the skin material and are at least partially pulled into the pull-in grooves together with the skin end portion.

2. The conveyance seat according to claim 1, wherein:
the pull-in grooves have:
first pull-in grooves for partitioning the pad material into a central pad portion and side pad portions located outside the central pad portion in a seat width direction; and
second pull-in grooves for partitioning the central pad portion into a first central pad portion and a second central pad portion in the seat width direction and a direction orthogonal to a thickness direction of the pad material, and
the heater connecting portions are at least partially pulled into the first pull-in grooves together with the skin end portion, and are disposed at positions aligned with or overlapping the second pull-in grooves.

3. The conveyance seat according to claim 2, wherein the first heater portion and the second heater portion are disposed at positions facing a portion of the seat body in contact with an occupant when the occupant is seated on the seat body, and are disposed at positions not facing the second pull-in grooves.

4. The conveyance seat according to claim 2, wherein the heater connecting portions are disposed outside the first heater portion and the second heater portion in the seat width direction.

5. The conveyance seat according to claim 2, wherein:
the first pull-in grooves are formed on right and left sides in the seat width direction,
the heater connecting portions are disposed on the right and left sides in the seat width direction, and
the right and left heater connecting portions are at least partially pulled into the right and left first pull-in grooves, respectively.

6. The conveyance seat according to claim 2, wherein:
the second pull-in grooves have a plurality of second pull-in grooves dividing the central pad portion into the first central pad portion, the second central pad portion, and a third central pad portion in the orthogonal direction,
the seat heater has:
a first heater portion disposed on a surface of the first central pad portion;
a second heater portion disposed on a surface of the second central pad portion;
a third heater portion disposed on a surface of the third central pad portion;
a first heater connecting portion connecting the first heater portion and the second heater portion; and
a second heater connecting portion connecting the second heater portion and the third heater portion, and
the first heater connecting portion and the second heater connecting portion are disposed at positions aligned in the orthogonal direction.

7. The conveyance seat according to claim 2, wherein:
the first pull-in grooves are formed on the right and left sides in the seat width direction,
the heater connecting portions are disposed on the right and left sides in the seat width direction, and
the right and left heater connecting portions are disposed at overlapping positions in the orthogonal direction and the thickness direction of the pad material.

8. The conveyance seat according to claim 1, wherein:
the seat heater has a sheet-shaped seat base material and a heater wire that is attached to the seat base material and extends along the seat base material, and a
portion of the heater wire attached to the seat base material of each of the heater connecting portions extends along an extending direction of each of the heater connecting portions and extends while forming a plurality of bent portions.

9. The conveyance seat according to claim 8, wherein the portion of the heater wire attached to the seat base material of each of the heater connecting portions extends while forming a meandering shape or a zigzag shape.

10. The conveyance seat according to claim 1, wherein an outer end portion of each of the heater connecting portions in the seat width direction is attached to the skin end portion by sewing.
